(19) United States
(12) Patent Application Publication
(10) Pub. No.: US 2026/0247478 A1
(43) Pub. Date: Aug. 20, 2026

(54) RIS ON-OFF PATTERN

(71) Applicant: QUALCOMM Incorporated, San Diego, CA (US)

(72) Inventors: Zhikun WU, Beijing (CN); Ahmed ELSHAFIE, San Diego, CA (US); Wanshi CHEN, San Diego, CA (US); Hyojin LEE, San Diego, CA (US); Yu ZHANG, San Diego, CA (US); Peter GAAL, San Diego, CA (US)

(21) Appl. No.: 19/162,034

(22) PCT Filed: Mar. 23, 2023
(86) PCT No.: PCT/CN2023/083332

§ 371 Date: Sep. 3, 2025

(51) Int. Cl. H04W 76/28; H04B 7/04

(52) U.S. Cl. CPC H04W 76/28; H04B 7/04013

(57) ABSTRACT

A UE may determine an on-off pattern configuration for a network node based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The on-off pattern configuration for the network node may be associated with a panel of the network node or a controller of the network node. The UE may transmit, via the transceiver, to the network node, the on-off pattern configuration for the network node. The network node may switch the panel of the network node or the controller of the network node on or off based on the on-off pattern configuration for the network node.

### TECHNICAL FIELD

The present disclosure relates generally to communication systems, and more particularly, to the configuration of a reconfigurable intelligent surface (RIS) by a user equipment (UE) in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may determine an on-off pattern configuration for a network node based on at least one of a discontinuous reception (DRX) on-off pattern associated with the UE, semi-persistent scheduling (SPS) associated with the UE, a configured grant associated with the UE, a sidelink grant associated with the UE, a wakeup signal (WUS) configuration associated with the UE, or a sensing-based resource selection for a mode 2 sidelink communication associated with the UE. The on-off pattern configuration for the network node may be associated with a panel of the network node or a controller of the network node. The apparatus may transmit, via the transceiver, to the network node, the on-off pattern configuration for the network node.

In an aspect of the disclosure, a method, a computer-readable medium, and an apparatus are provided. The apparatus may be a network node. The apparatus may receive, from a UE, an on-off pattern configuration for the network node. The on-off pattern configuration for the network node may be associated with a panel of the network node or a controller of the network node. The on-off pattern configuration for the network node may be based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The apparatus may switch the panel of the network node or the controller of the network node on or off based on the on-off pattern configuration for the network node.

In an aspect of the disclosure, a method, a computer-readable medium, and an apparatus are provided. The apparatus may be a UE. The apparatus may identify a UE communication pattern. The UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The apparatus may transmit, via the transceiver, to a network node, an indication of the UE communication pattern.

In an aspect of the disclosure, a method, a computer-readable medium, and an apparatus are provided. The apparatus may be a network node. The apparatus may receive, from a UE, an indication of a UE communication pattern. The UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The apparatus may determine an on-off pattern configuration for the network node based on the received indication of the UE communication pattern. The on-off pattern configuration for the network node may be associated with a panel of the network node or a controller of the network node. The apparatus may switch the panel of the network node or the controller of the network node on or off based on the on-off pattern configuration for the network node.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example environment according to one or more aspects.

FIG. 5 is a diagram illustrating DRX cycle.

FIG. 6 is a diagram illustrating example UE DRX states and RIS on-off states over time.

FIG. 7 is a diagram illustrating example UE DRX states and RIS on-off states over time.

FIG. 8 is a diagram illustrating example UE DRX states and RIS on-off states over time.

FIG. 9 is a diagram illustrating example UE DRX states and RIS on-off states over time.

FIG. 10 is a diagram illustrating example UE DRX states and RIS on-off states over time.

FIG. 11 is a diagram illustrating example UE DRX states and RIS on-off states over time.

FIG. 12 is a diagram illustrating example RIS on-off states over time.

FIG. 13 is a diagram illustrating example RIS on-off states over time.

FIGS. 14 and 15 are diagrams illustrating example RIS on-off states over time.

FIG. 16 is a diagram illustrating example UE DRX states and RIS on-off states over time.

FIG. 17 is a diagram illustrating example UE periodic traffic and RIS on-off states over time.

FIG. 18 is a diagram of a communication flow of a method of wireless communication.

FIG. 19 is a flowchart of a method of wireless communication.

FIG. 20 is a flowchart of a method of wireless communication.

FIG. 21 is a flowchart of a method of wireless communication.

FIG. 22 is a flowchart of a method of wireless communication.

FIG. 23 is a diagram of a communication flow of a method of wireless communication.

FIG. 24 is a flowchart of a method of wireless communication.

FIG. 25 is a flowchart of a method of wireless communication.

FIG. 26 is a flowchart of a method of wireless communication.

FIG. 27 is a flowchart of a method of wireless communication.

FIG. 28 is a diagram illustrating an example of a hardware implementation for an example apparatus and/or network entity.

FIG. 29 is a diagram illustrating an example of a hardware implementation for an example network entity.

### DETAILED DESCRIPTION

A RIS may include a 2-dimensional (2-D) antenna array that may be composed of individual scattering elements. The scattering elements may further include reconfigurable meta-surfaces, which may fully control the phase shifts induced (incurred) by the individual scattering elements. Characterized by a simple structure and low cost, the RIS may be extensively deployed in a cellular wireless communication system to improve the system performance. When a RIS is not serving UEs, the RIS panel and/or the RIS controller of the RIS may be switched off, to avoid interference to other UEs and to reduce power consumption. Further, a UE may periodically enter a sleep mode based on a DRX pattern. Control of the on-off behavior at a RIS by a UE based on the UE DRX pattern may be desired.

According to various aspects, a UE may determine an on-off pattern configuration for a network node based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The on-off pattern configuration for the network node may be associated with a panel of the network node or a controller of the network node. The UE may transmit, via the transceiver, to the network node, the on-off pattern configuration for the network node. The network node may switch the panel of the network node or the controller of the network node on or off based on the on-off pattern configuration for the network node. Accordingly, in some configurations, the RIS may be switched off to reduce interference and save power while the UE is in the DRX off duration, and may be switched on to serve the UE while the UE is in the DRX on duration.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

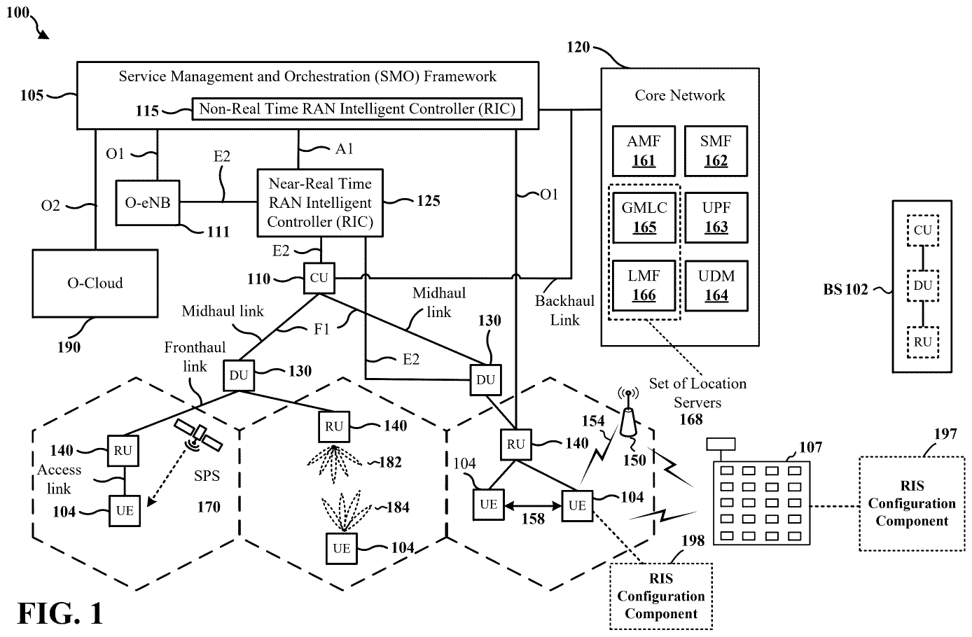

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a RIS configuration component 198 that may be configured to determine an on-off pattern configuration for a network node based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The on-off pattern configuration for the network node may be associated with a panel of the network node or a controller of the network node. The RIS configuration component 198 may be configured to transmit, via the transceiver, to the network node, the on-off pattern configuration for the network node. In certain aspects, the RIS 107 may have a RIS configuration component 197 that may be configured to receive, from a UE, an on-off pattern configuration for the network node. The on-off pattern configuration for the network node may be associated with a panel of the network node or a controller of the network node. The on-off pattern configuration for the network node may be based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The RIS configuration component 197 may be configured to switch the panel of the network node or the controller of the network node on or off based on the on-off pattern configuration for the network node.

In some configurations, the RIS configuration component 198 may be configured to identify a UE communication pattern. The UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The RIS configuration component 198 may be configured to transmit, via the transceiver, to a network node, an indication of the UE communication pattern. In certain aspects, the RIS configuration component 197 may be configured to receive, from a UE, an indication of a UE communication pattern. The UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The RIS configuration component 197 may be configured to determine an on-off pattern configuration for the network node based on the received indication of the UE communication pattern. The on-off pattern configuration for the network node may be associated with a panel of the network node or a controller of the network node. The RIS configuration component 197 may be configured to switch the panel of the network node or the controller of the network node on or off based on the on-off pattern configuration for the network node.

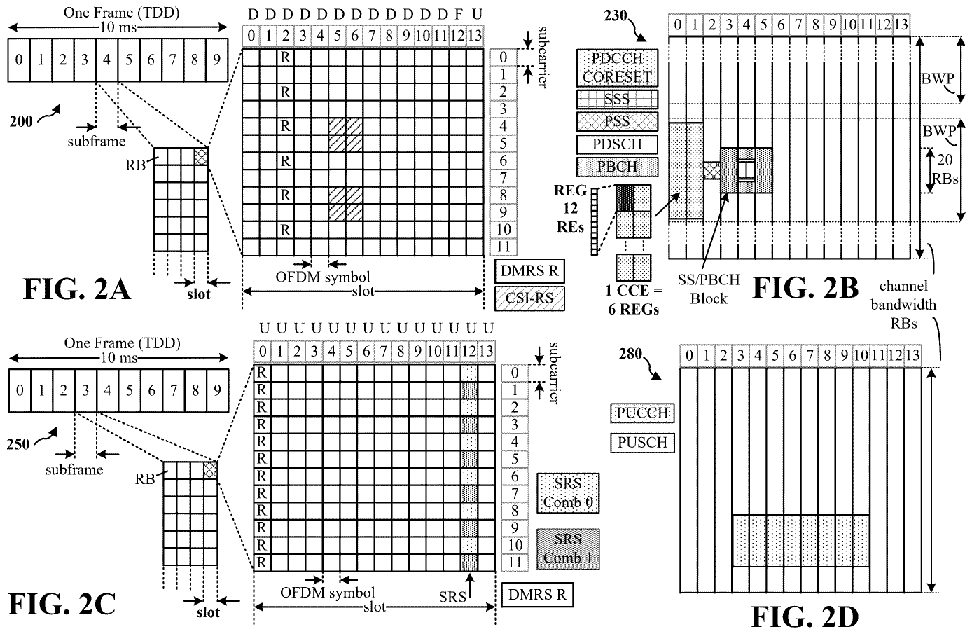

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2ª *15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

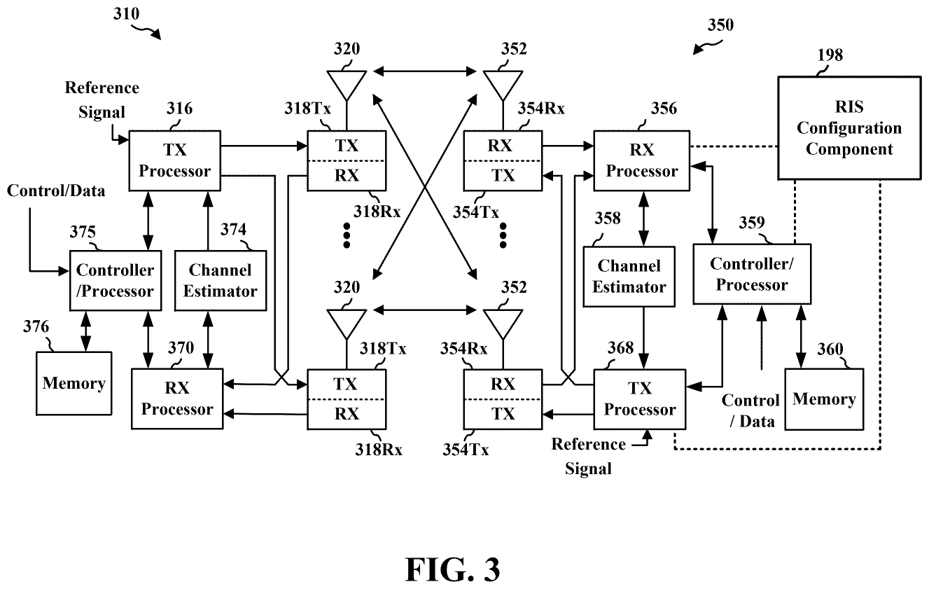

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RIS configuration component 198 of FIG. 1.

A RIS may include a 2-dimensional antenna array that may be composed of individual scattering elements. The scattering elements may further include reconfigurable meta-surfaces, which may fully control the phase shifts induced (incurred) by the individual scattering elements. Characterized by a simple structure and low cost, the RIS may be extensively deployed in a cellular wireless communication system to improve the system performance.

Aspects associated with the deployment of the RIS technology may include, for example, the use scenario/use-case, channel models/modeling, the control interface, beam management, CSI enhancement, the initial access, random access channel (RACH) enhancement, interference management, backward compatibility, RS enhancement, reciprocity, communication models, evaluation methodology, the impact on networks, and so on.

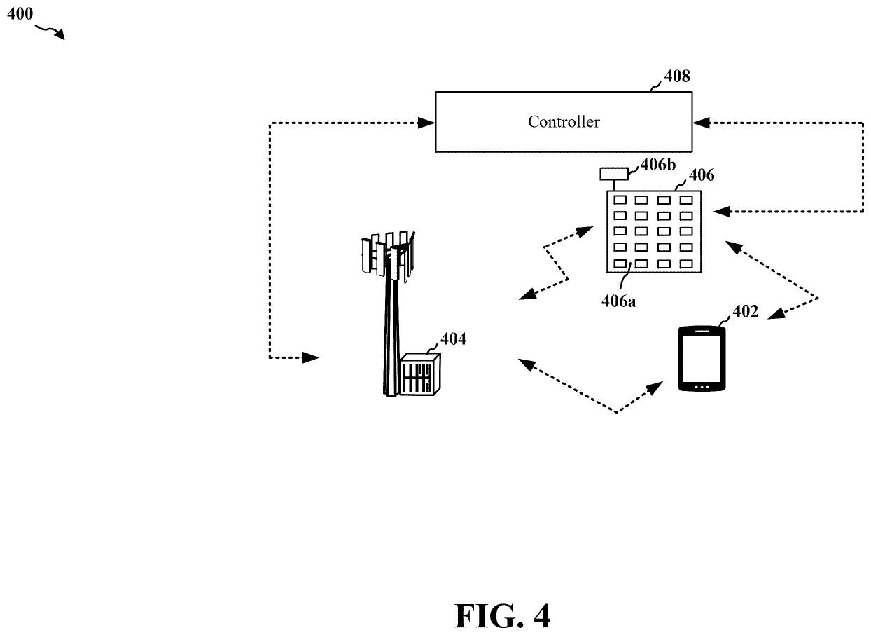

FIG. 4 is a diagram illustrating an example environment 400 according to one or more aspects. As shown, the communication between a network entity 404 (e.g., a base station) and a UE 402 may be assisted by a RIS 406. In some configurations, the network entity 404 and the RIS 406 may be controlled by a controller (entity) 408. Hereinafter a RIS panel 406a may refer to a panel with RIS elements, where the electromagnetic (EM) characteristics (e.g., the phase shift) of the RIS elements may be configurable. In some configurations, the RIS panel 406a may be further divided into sub-panels.

A RIS controller 406b may refer to a device that may receive RIS configurations from another entity (e.g., the network, a network entity (e.g., a base station), or a UE). The RIS controller 406b may configure the RIS panel 406a based on the received RIS configurations. In some configurations, a RIS controller 406b may be connected to more than one RIS panel (e.g., the RIS panel 406a).

In different configurations, the power supply to the RIS panel (e.g., the RIS panel 406a) or the RIS elements of the RIS panel (e.g., the RIS panel 406a) may be switched on or off (i.e., set to the on state or the off state). In some configurations, a RIS panel (e.g., the RIS panel 406a) may be able to reflect signals if switched on, and may not be able to reflect signals if switched off. In some other configurations, a RIS panel (e.g., the RIS panel 406a) may be able to reflect signals with a configurable/changeable direction of reflection if switched on, and may be able to reflect signals with a fixed/preconfigured direction of reflection if switched off.

In different configurations, a RIS controller (e.g., the RIS controller 406b) may be switched on or off. If switched on, the RIS controller (e.g., the RIS controller 406b) may be able to monitor channels (e.g., similar to a UE in the DRX on duration), may communicate (transmit/receive) with the network, or may change the configurations of the RIS panel (e.g., the RIS panel 406a). In contrast, if switched off, the RIS controller (e.g., the RIS controller 406b) may not be able to monitor channels (e.g., similar to a UE in the DRX off duration), may not communicate with the network, or may not change the configurations of the RIS panel (e.g., the RIS panel 406a).

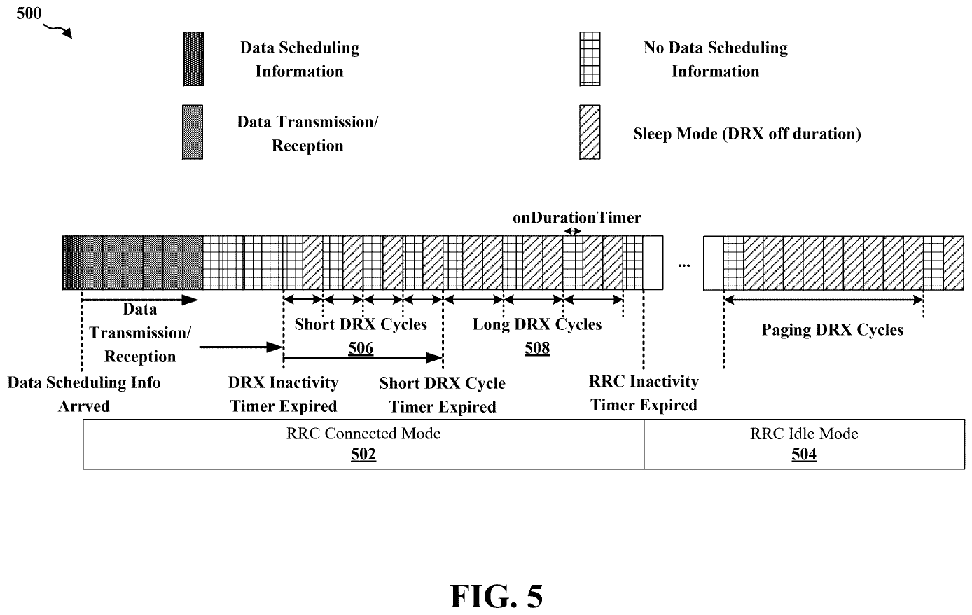

FIG. 5 is a diagram 500 illustrating DRX cycles. A UE may perform PDCCH monitoring to detect data scheduling information when the UE is not in a DRX off duration. In a DRX cycle, the UE may enter a DRX off duration of a certain length if the UE does not receive data scheduling information while the UE is in the DRX on duration. Accordingly, DRX may be a mechanism based on which a UE may enter a sleep mode for a certain period of time (i.e., a DRX off duration) and may wake up for another period of time (i.e., a DRX on duration). The UE in the sleep mode may not perform PDCCH monitoring. As a result, power savings may be achieved. The DRX mechanism may work while the UE is in the RRC Connected mode 502 or the RRC Idle mode 504. DRX in the RRC Connected mode 502 may be referred to as connected DRX (C-DRX), and DRX in the RRC Idle mode 504 may be referred to as Idle Mode DRX.

The C-DRX may include two stages: the short DRX cycles 506 and the long DRX cycles 508. Each long DRX cycle 508 may be lengthier in time than a short DRX cycle 506, and may include a longer DRX off duration than a short DRX cycle 506. The short DRX cycles may be used to avoid immediate action for the longer sleeping mode of the long DRX cycle.

In different aspects described hereinafter, any reference to a RIS (panel) being switched on or off may include a reference to the corresponding RIS controller being switched on or off. Different actions or states of the RIS panel and the RIS controller while each of the RIS panel and the RIS controller is switched on or off may be summarized in Table 2 below.

TABLE 2
RIS on-off states

| | RIS panel | RIS controller |
|---|---|---|
| On state | 1. RIS elements may reflect | 1. RIS controller may monitor |
| | impinging signals; | DL channels (similar to C- |
| | 2. RIS elements may reflect | DRX on); and/or |
| | impinging signals to target | 2. RIS controller may actively |
| | directions; or | transmit signaling (similar to |
| | 3. RIS elements may reflect | discontinuous transmission |
| | signals to a target direction | (DTX) on). |
| | (e.g., controlled by the instant | |
| | UE). | |
| Off state | 1. RIS elements may not | 1. RIS controller may not |
| | reflect impinging signals; | monitor DL channels (similar |
| | 2. RIS elements may be set in | to C-DRX off); and/or |
| | a “default” state, may not | 2. RIS controller may not |
| | control the direction of the | actively transmit signaling |
| | reflect signals (e.g., similar | (similar to DTX off). |
| | to a mirror/scatterer); or | |
| | 3. RIS elements may reflect | |
| | signals to other directions | |
| | (e.g., not controlled by any | |
| | UE, or controlled by another | |
| | UE). | |

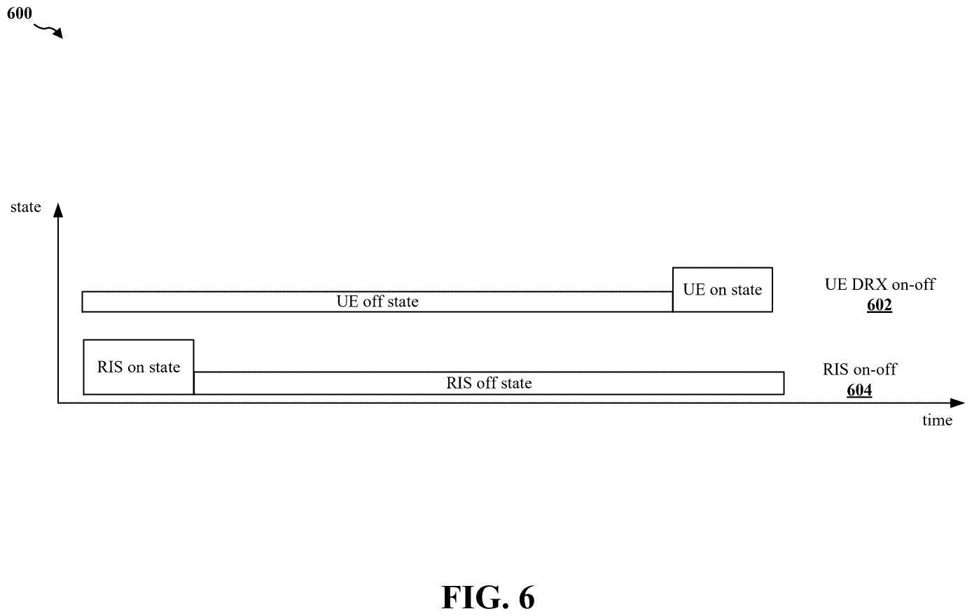

FIG. 6 is a diagram 600 illustrating example UE DRX states and RIS on-off states over time. When a RIS is not serving UEs, the RIS panel and/or the RIS controller of the RIS may be switched off, to avoid interference to other UEs and to reduce power consumption. The RIS on-off states 604 may show the RIS (e.g., the RIS panel and/or the RIS controller) being in the on state or in the off state over time. Further, as shown at the UE DRX states 602, a UE may be configured with DRX. That is, over time, the UE may be in the DRX on state or a DRX off state. The UE may monitor for the PDCCH when the UE is in the DRX on state, and may not perform PDCCH monitoring when the UE is in the DRX off state.

In different configurations, the on-off behavior of the RIS panel/controller may be adjusted based on the state of a UE served by the RIS. For example, as shown in FIG. 6, the RIS may be in the off state while the UE is in the DRX on state, potentially leaving the UE unserved by the RIS during the UE DRX on duration. This mismatch between the UE DRX pattern (C-DRX pattern or Idle Mode DRX pattern) and the RIS on-off pattern may be undesired as the UE may be unserved by the RIS while the UE is actively transmitting or receiving and the RIS may waste power being in the on state while the UE is in the sleep mode.

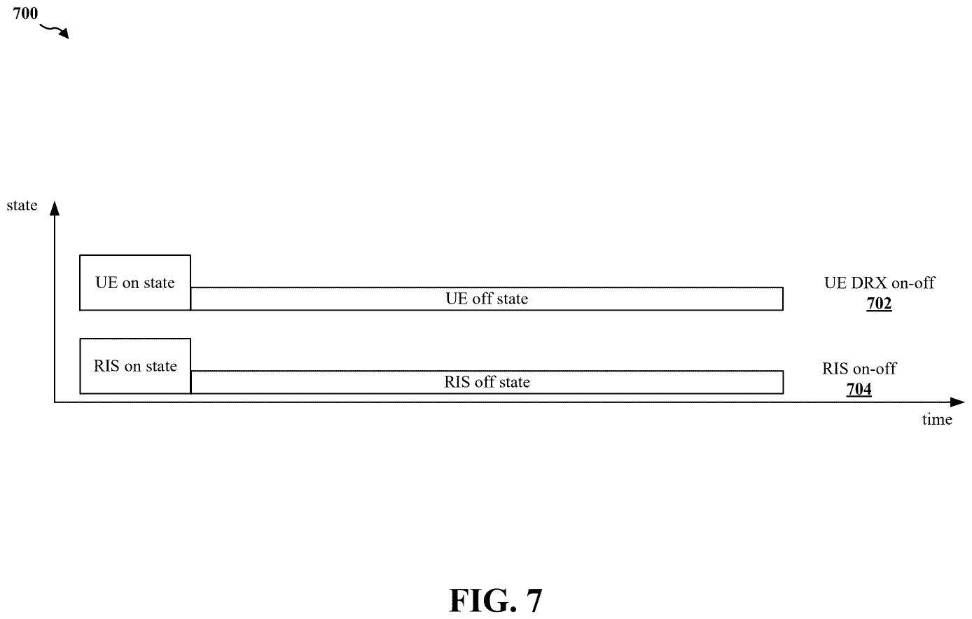

FIG. 7 is a diagram 700 illustrating example UE DRX states and RIS on-off states over time. In some configurations, a UE may transmit a configuration of a RIS on-off pattern to the RIS (in particular, the RIS controller). The RIS controller may then switch the RIS (RIS panel and/or RIS controller) on or off based on the received RIS on-off pattern configuration. In particular, in different configurations, the RIS on-off pattern may be based on (e.g., aligned with) at least one of the UE DRX (on-off) pattern, SPS of the UE, one or more configured grants for the UE, or one or more sidelink grants for the UE. Therefore, as shown in the example of FIG. 7, the UE DRX states 702 and the RIS on-off states 704 may be aligned. In other words, the RIS may be in the on state to serve the UE while the UE in the DRX on duration. Further, the RIS may be in the off state to save power while the UE is in the sleep mode (DRX off duration).

In one configuration, the RIS on-off pattern configuration for the RIS panel may include separate on-off pattern configurations for individual RIS sub-panels. In one configuration, the RIS controller may be connected to and control multiple RIS panels, and the RIS on-off pattern configuration received by the RIS controller may include on-off pattern configurations for one or more particular RIS panels controlled by the RIS controller. In some further configurations, the RIS on-off pattern configuration may be generated and provided by a network entity (e.g., a base station).

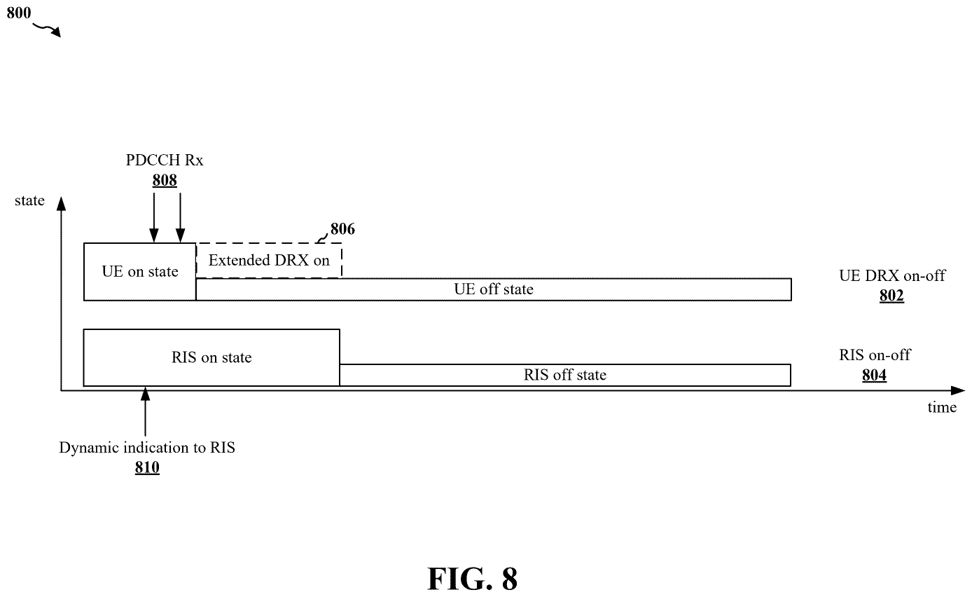

FIG. 8 is a diagram 800 illustrating example UE DRX states and RIS on-off states over time. As shown, a current UE DRX on duration may be extended based on the reception at the UE of one or more PDCCHs 808 via the Uu interface. If the RIS on-off pattern is configured to be aligned with the UE DRX states, in some configurations, a RIS on state period may be extended as well based on the UE DRX on duration extension (e.g., the extended DRX on duration 806).

FIG. 8 may show the UE DRX states 802 and the RIS on-off states 804 over time. In some configurations, the RIS on-off pattern may include one or more redundancy slots during which the RIS may be left in the on state to accommodate the UE DRX on duration extension. In one configuration, the redundancy slots may be preconfigured. For example, the RIS may be left in the on state for a preconfigured “X” slots after the end of the original UE DRX on duration (i.e., without any UE DRX on duration extension), where the preconfigured “X” slots may accommodate the UE DRX on duration extension. In another example (not shown), the UE DRX on duration extension may be before the beginning of the original UE DRX on duration. Accordingly, the RIS may be turned on at a number of slots before the beginning of the original UE DRX on duration to accommodate the UE DRX on duration. In another configuration, the redundancy slots may be dynamically configured by the UE (e.g., based on the dynamic indication 810) (e.g., during the original UE DRX on duration once the UE becomes aware that the DRX on duration is to be extended). In different configurations, the dynamic indication from the UE of the redundancy slot configuration may include one or more of a UE identifier (ID), timing information (i.e., the duration for which the RIS is to be left in the on state after the end of the original DRX on duration, e.g., “X” slots), or beam information. In one configuration, the RIS (in particular, the RIS controller) may provide a feedback to the UE to indicate whether the RIS may implement (accept) the dynamically configured redundancy slots. Further, the UE may report to a network entity (e.g., a base station) whether the RIS may implement (accept) the dynamically configured redundancy slots.

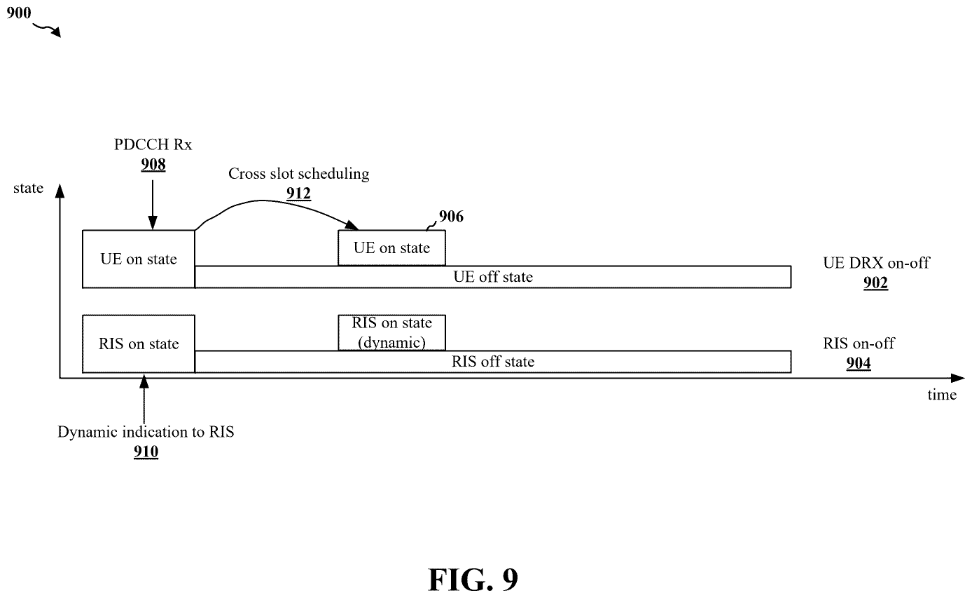

FIG. 9 is a diagram 900 illustrating example UE DRX states and RIS on-off states over time. FIG. 9 may show the UE DRX states 902 and the RIS on-off states 904 over time. In some configurations, a current UE DRX on duration may be increased based on cross slot scheduling (e.g., cross slot scheduling 912 based on the received PDCCH 908) via the Uu interface. If the RIS on-off pattern is configured to be aligned with the UE DRX states, in some configurations, a RIS on state period may be increased as well (e.g., an additional RIS on state period may be implemented) based on the UE DRX on duration increase (e.g., the increased/additionally scheduled DRX on duration 906).

In one configuration, the increased (additional) RIS on state period may be dynamically configured by the UE (e.g., based on the dynamic indication 910) (e.g., during the original UE DRX on duration once the UE becomes aware that an increased DRX on duration is scheduled). In different configurations, the dynamic indication from the UE of the configuration of the increased (additional) RIS on state period may include one or more of a UE identifier (ID), timing information (i.e., the time and the duration of the increased (additional) RIS on state period), or beam information. In one configuration, the RIS (in particular, the RIS controller) may provide a feedback to the UE to indicate whether the RIS may implement (accept) the dynamically configured increased (additional) RIS on state period. Further, the UE may report to a network entity (e.g., a base station) whether the RIS may implement (accept) the dynamically configured increased (additional) RIS on state period.

It should be noted that any aspects relating to the UE DRX on-off states described hereinafter may also include, or may be extended to include, corresponding aspects relating to other UE scheduling or grant information (e.g., including but not limited to SPS for the UE, one or more configured grants for the UE, sidelink mode 1/mode2 TX/RX time-frequency resources, periodic configurations such as the CSI-RS or the SRS, etc.).

In one or more configurations, in addition to configuring and activating the RIS on-off patterns (e.g., by transmitting the corresponding configuration to the RIS controller), the UE may also deactivate one or more RIS on-off patterns (e.g., by transmitting a deactivating configuration to the RIS controller). In response to the deactivation of the RIS on-off pattern configuration, the RIS panel or the RIS controller may enter the sleep mode early.

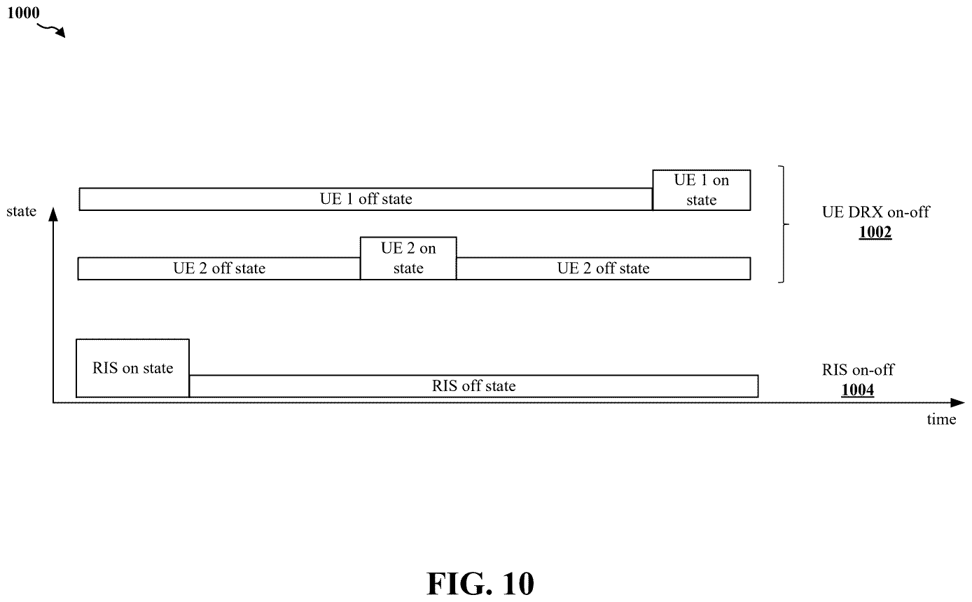

FIG. 10 is a diagram 1000 illustrating example UE DRX states and RIS on-off states over time. FIG. 10 may show the UE DRX states 1002 for 2 UEs (UE1 and UE2) and the RIS on-off states 1004 over time. In different configurations, the on-off behavior of the RIS panel/controller may be adjusted based on the states of the multiple UEs served by the RIS. The RIS may waste power being in the on state while all the multiple UEs served by the UE are in the sleep mode. On the other hand, at least some of the multiple UEs may be left unserved by the RIS if the RIS is in the off state while at least some of the multiple UEs are in the DRX on duration.

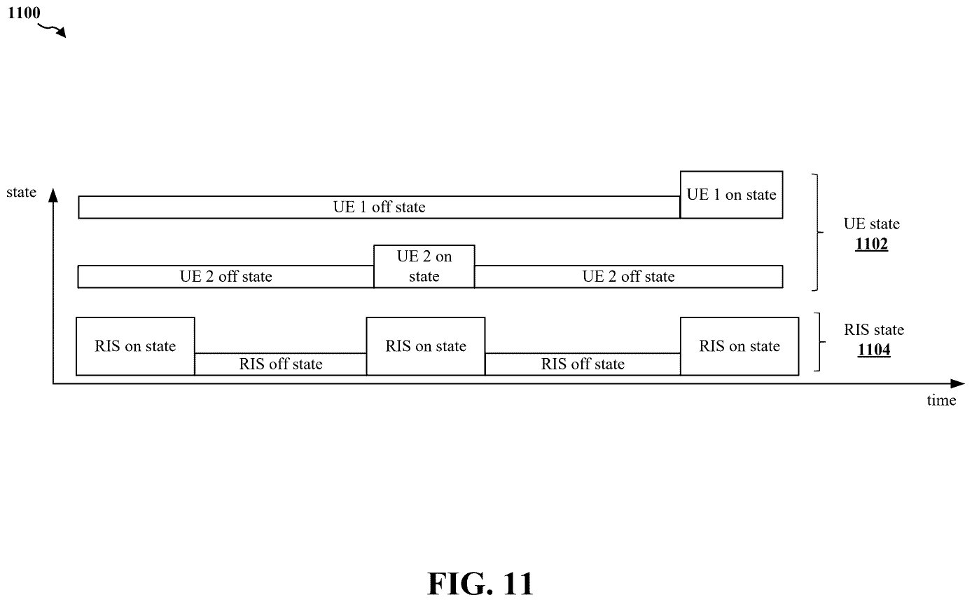

FIG. 11 is a diagram 1100 illustrating example UE DRX states and RIS on-off states over time. FIG. 11 may show the UE DRX states 1102 for 2 UEs (UE1 and UE2) and the RIS on-off states 1104 over time. In some configurations, if a RIS serves multiple UEs, each of the multiple UEs may transmit a respective RIS on-off pattern configuration to the RIS (in particular, the RIS controller) based on the respective DRX state pattern of the UE. Accordingly, the RIS may be configured with multiple RIS on-off patterns, each RIS on-off pattern corresponding to one of the multiple UEs served by the RIS. In one or more configurations, the RIS may switch to the on state when at least one of the multiple configured RIS on-off patterns indicates the on state, and may switch to the off state when all of the multiple configured RIS on-off patterns indicate the off state. Accordingly, the RIS may be in the off state when all the multiple UEs served by the RIS are in the DRX off duration.

In some configurations, the number of RIS on-off patterns configured at a RIS may be subject to an upper limit. The upper limit may be preconfigured. In other words, the RIS may not be configured with more than “X” on-off patterns, where the value of “X” may be preconfigured. Accordingly, where each served UE provides a single respective RIS on-off pattern configuration, the RIS may not be controlled by more than “X” UEs at a time based on the preconfigured upper limit.

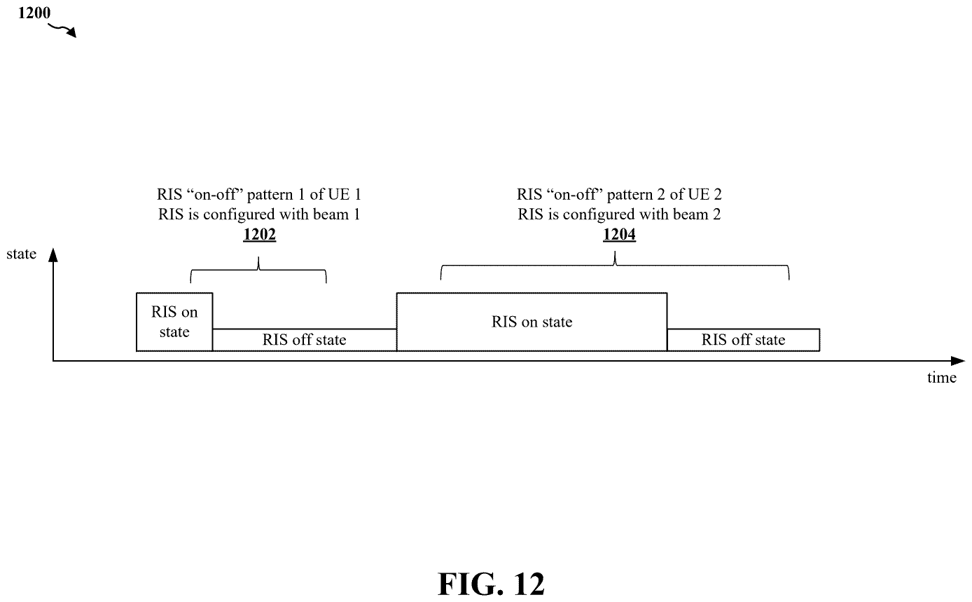

FIG. 12 is a diagram 1200 illustrating example RIS on-off states over time. In one or more configurations, the RIS may be configured with multiple RIS on-off patterns (e.g., the RIS on-off patterns 1202 and 1204), where each of the multiple RIS on-off pattern may correspond to a respective DRX pattern of one of multiple UEs served by the RIS. In one or more configurations, for different served UEs in different RIS on occasions/periods, the RIS may use correspondingly different reflection beams. For example, if a first RIS on occasion/period correspond to a DRX on duration of a first UE served by the RIS, the RIS may use a reflection beam corresponding to (e.g., most suitable for) the first UE in the first RIS on occasion/period.

In one or more configurations, each of the configured RIS on-off patterns may be associated with a respective ID. In one or more configurations, each of the configured RIS on-off patterns (which may be associated with a RIS on-off pattern ID) may be associated the ID of the corresponding UE. In one or more configurations, each of the configured RIS on-off patterns may be associated with a respective transmission configuration indicator (TCI) state (e.g., the TCI state may be configured at the RIS controller). Preconfigured TCI states may be used if the moving speed of the UE is slow (e.g., less than a threshold). If the UE moving speed is fast (e.g., greater than the threshold), the TCI state may be dynamically configured by a network entity (e.g., a base station).

In some configurations, a single configured RIS on-off patterns may be associated with multiple corresponding UEs (and the multiple IDs of the multiple corresponding UE). In some configurations, a single configured RIS on-off patterns may be associated with a UE group ID.

In some configurations, at least some of the multiple configured RIS on-off patterns at the RIS may be deactivated/disabled, while the rest of the multiple configured RIS on-off patterns may be activated/enabled. In some configurations, a UE may transmit an indication (i.e., a command) to the RIS (in particular, the RIS controller) to enable or disable a configured RIS on-off pattern. In particular, a RIS on-off pattern may be identified in the activation/deactivation command provided by the UE based on at least one of the ID of the RIS on-off pattern, a radio network temporary identifier (RNTI), the ID of the corresponding UE, or the UE group ID.

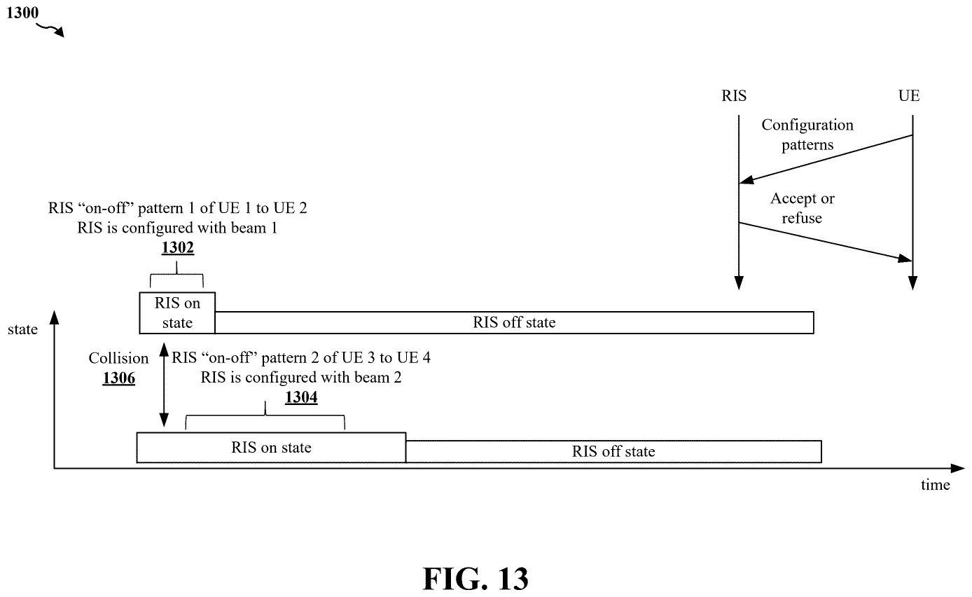

FIG. 13 is a diagram 1300 illustrating example RIS on-off states over time. In some configurations, where multiple RIS on-off patterns associated with multiple served UEs are configured at the RIS, collision between the RIS on-off patterns may occur. For example, as shown in the diagram 1300, a collision 1306 may occur between the first RIS on-off pattern configuration 1302 that specifies the use of beam 1 at the time of collision and the second RIS on-off pattern configuration 1304 that specifies the use of beam 2 at the time of collision. In different configurations, the collision between multiple RIS on-off pattern configurations may be resolved in various ways.

In one configuration, each of the multiple RIS on-off patterns may be associated with a respective priority (priority value). Accordingly, when collision between multiple RIS on-off patterns occurs, the RIS on-off pattern with the higher/highest priority may take precedence, and the RIS may apply the RIS on-off pattern with the higher/highest priority. In some configurations, the priority of a RIS on-off pattern may be changed dynamically (e.g., based on a dynamic indication from a UE). In one configuration, the RIS may determine the RIS on-off pattern to apply when collision between multiple RIS on-off patterns occurs. Further, the RIS may indicate to each of the multiple UEs involved in the RIS on-off pattern configuration collision whether the respective RIS on-off pattern configuration associated with the UE is to be applied (i.e., whether the respective RIS on-off pattern configuration associated with the UE is accepted). In some further configurations, the RIS may indicate to each of the multiple served UEs whether the respective RIS on-off pattern configuration associated with the UE is to be applied.

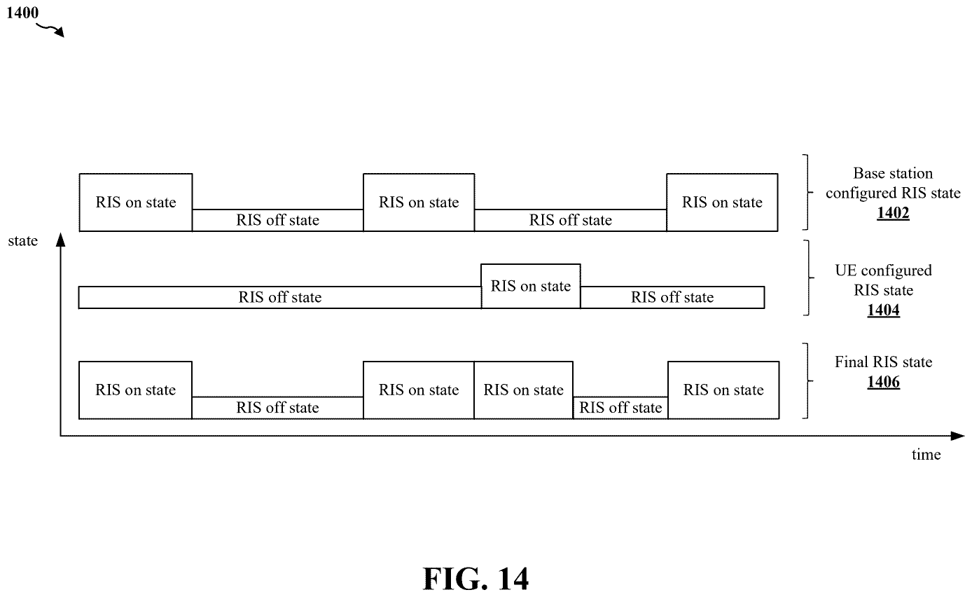

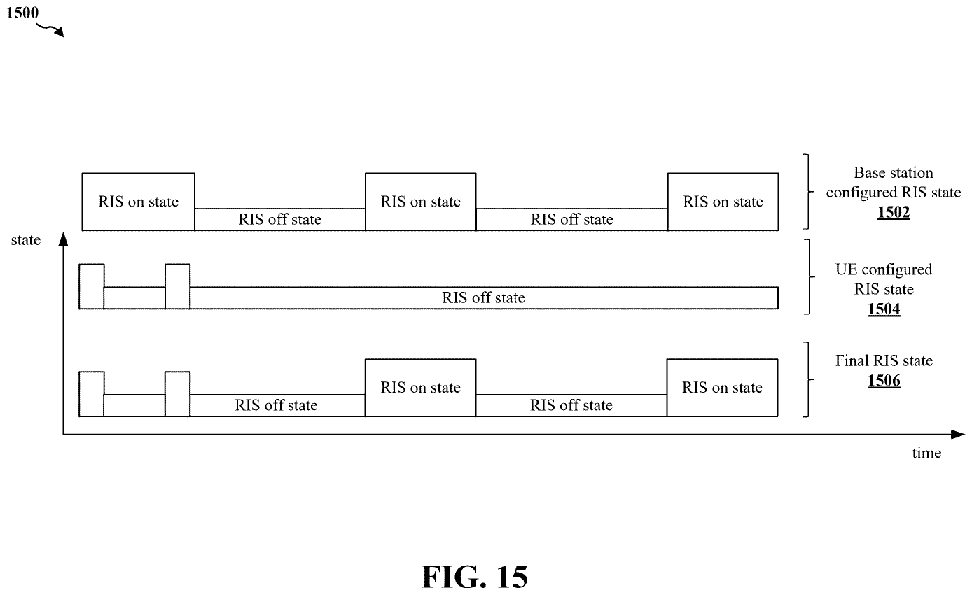

FIGS. 14 and 15 are diagrams 1400 and 1500 illustrating example RIS on-off states over time. As shown, a network entity (e.g., a base station) may transmit a RIS on-off pattern configuration 1402, 1502 to the RIS. For example, the network entity may provide the network-provided RIS on-off pattern configuration 1402, 1502 based on interference to other cells. For example, based on the network-provided RIS on-off pattern configuration, the RIS may be in the on state for 30% of the time and be in the off state for 70% of the time. Further, a UE may transmit a RIS on-off pattern configuration 1404, 1504 to the RIS. For example, the UE may provide the UE-provided RIS on-off pattern configuration 1404, 1504 based on the UE DRX pattern, as described above. In one or more configurations, the final RIS on-off pattern 1406, 1506 implemented by the RIS may be based on the network-provided RIS on-off pattern configuration 1402, 1502 and the UE-provided RIS on-off pattern configuration 1404, 1504. In some configurations, if a collision between a network-provided RIS on-off pattern configuration and a UE-provided RIS on-off pattern configuration occurs, the collision may be resolved in one of various ways. For example, the network-provided RIS on-off pattern configuration and the UE-provided RIS on-off pattern configuration may be each associated with a priority. When a collision between the network-provided RIS on-off pattern configuration and the UE-provided RIS on-off pattern configuration occurs, the RIS on-off pattern configuration with the higher priority may take precedence, and the RIS may implement the RIS on-off pattern configuration with the higher priority. In some examples, a network-provided RIS on-off pattern configuration may be assumed to have a higher priority than the UE-provided RIS on-off pattern configuration.

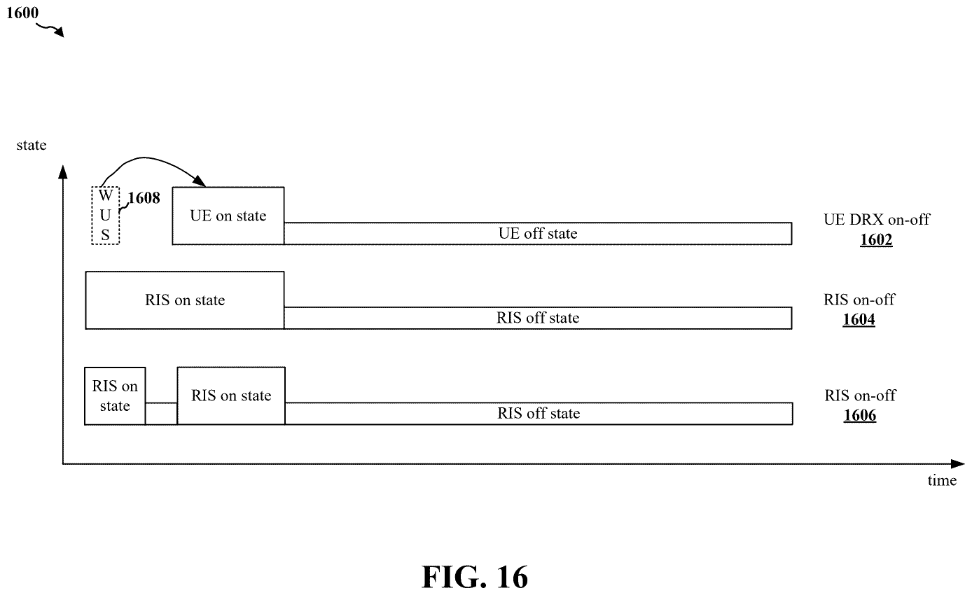

FIG. 16 is a diagram 1600 illustrating example UE DRX states and RIS on-off states over time. In some configurations, the UE may receive a wakeup signal (WUS) (e.g., WUS 1608) (e.g., included in a DCI message) from the network, where the WUS may notify the UE whether there is data for the UE in the upcoming DRX on duration. If the WUS indicates that there is no data for the UE in the upcoming DRX on duration (or if the UE receives no WUS when a WUS is expected), the UE may immediately return to the off state, and may remain off through the DRX on duration until the next DRX on duration (i.e., skipping the DRX on duration). In other words, a current UE DRX on state may be canceled based on a WUS from the network (or an absence of a WUS). The UE on-off states 1602 may show that the WUS 1608 may indicate that there is data for the UE in the upcoming UE DRX on duration. Accordingly, the UE may enter the DRX on state for the UE DRX on duration. In some configurations, if the RIS on-off pattern is determined by the RIS, the UE (or the base station) may transmit information related to the configuration of the WUS (e.g., including the timing of the WUS) to the RIS, such that the RIS may be turned on when the UE is due to receive a WUS. Accordingly, the reception of the WUS by the UE may be assisted by the RIS. In some configurations, if the RIS on-off pattern is determined by the UE (or the base station), the UE (or the base station) may include, in the RIS on-off pattern configuration, an additional RIS on period (e.g., redundant slots) before the RIS on period corresponding to the UE DRX on duration, such that the RIS may be placed in the on state during the additional RIS on period to assist the UE in the reception of the WUS. As shown, the example RIS on-off states 1604 may show the additional RIS on period (for the WUS) and the RIS on period corresponding to the UE DRX on duration being merged into a single longer RIS on period. Further, the example RIS on-off states 1606 may show the additional RIS on period (for the WUS) being a separate RIS on period before the RIS on period corresponding to the UE DRX on duration. In some configurations, if the UE does not a receive a WUS (or if the WUS indicates that there is no data for the UE), the UE may know that it may not wake up for the one or more upcoming UE DRX on durations. Accordingly, the UE may indicate the skipping of the one or more upcoming UE DRX on durations to the RIS, and the RIS may remain in the off state accordingly (e.g., the RIS on states may be disabled/skipped for a certain duration or a number of times, etc.).

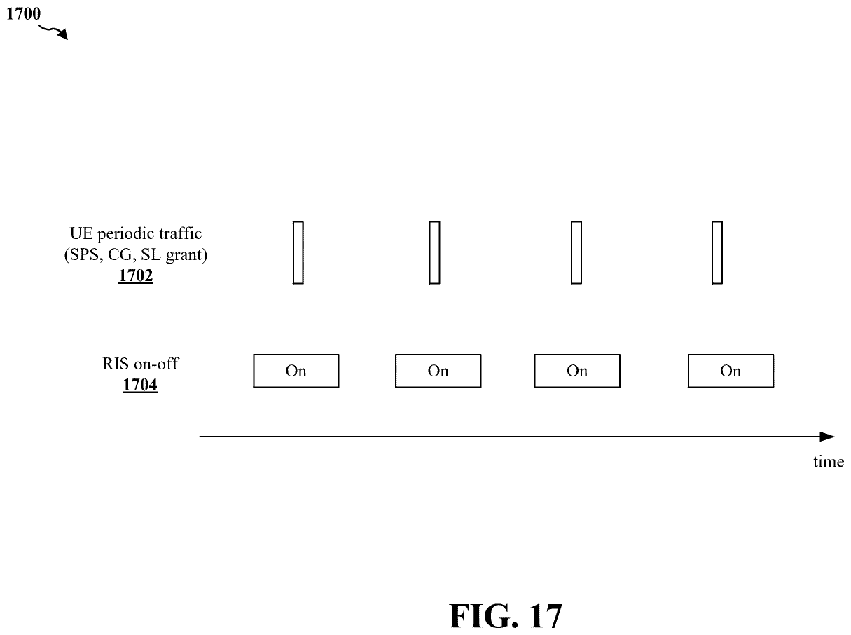

FIG. 17 is a diagram 1700 illustrating example UE periodic traffic and RIS on-off states over time. As shown, in some configurations, the UE may transmit or receive communications 1702 based on at least one of SPS, a configured grant, or a sidelink grant. The UE communications 1702 may correspond to periodic traffic based on at least one of SPS, a configured grant, or a sidelink grant. Accordingly, the RIS on-off states 1704 may be configured such that the RIS may be switched on based on an on-off pattern that may match the communications 1702 (e.g., periodic communications) of the UE to assist in the UE communications. In particular, the RIS may be switched on when there is traffic at the UE. In some additional configurations, the UE communications 1702 may be based on mode 2 sidelink communication (i.e., sidelink communication based on sensed available slots) or PSBCH slots. For example, in one configuration, the UE may, based on mode 2 sidelink communication, identify (sense) time-frequency resources to be used for sidelink communication. The UE may transmit an indication of the identified (sensed) time-frequency resources (in particular, an indication of the time domain resources) to the RIS. Based on the indication of the identified (sensed) time-frequency resources and to assist in the mode 2 sidelink communication, the RIS may be switched on at the same time as the UE transmits the sidelink communication based on the identified (sensed) time-frequency resources. In some configurations, upon receiving the indication of the identified (sensed) time-frequency resources, the RIS may respond to the UE to indicate that the RIS may provide assistance according to the identified (sensed) time-frequency resources (e.g., in the corresponding slots).

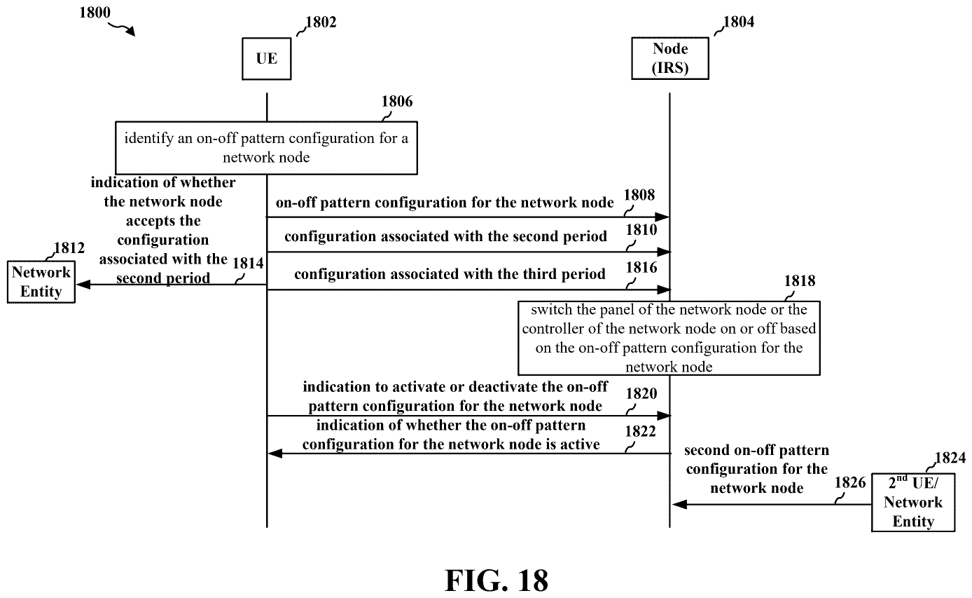

FIG. 18 is a diagram of a communication flow 1800 of a method of wireless communication. The UE 1802 may implement aspects of the UE 104/350. The network node 1804 may implement aspects of the RIS 107/406. At 1806, the UE 1802 may determine an on-off pattern configuration for a network node 1804 based on at least one of a DRX on-off pattern associated with the UE 1802 (e.g., as shown in 702, 802, 902 with reference to FIGS. 7-9), SPS associated with the UE 1802 (e.g., as shown in 1702 with reference to FIG. 17), a configured grant associated with the UE 1802 (e.g., as shown in 1702 with reference to FIG. 17), a sidelink grant associated with the UE 1802 (e.g., as shown in 1702 with reference to FIG. 17), a WUS configuration associated with the UE 1802 (e.g., as shown in 1608 with reference to FIG. 16), or a sensing-based resource selection for a mode 2 sidelink communication associated with the UE 1802. The on-off pattern configuration for the network node 1804 may be associated with a panel of the network node 1804 or a controller of the network node 1804. In general, the panel/controller of the network node 1804 may be switched on so that the network node 1804 may assist in the communication of the UE 1802 when the UE 1802 may be expected to transmit (e.g., in the uplink or the sidelink) and/or receive (e.g., in the downlink or the sidelink). The time periods during which the UE 1802 may be expected to transmit and/or receive may be identified based on one or more factors. For example, as described above, such time periods may be identified based on one or more of a DRX on-off pattern associated with the UE 1802 (e.g., as shown in 702, 802, 902 with reference to FIGS. 7-9), SPS associated with the UE 1802 (e.g., as shown in 1702 with reference to FIG. 17), a configured grant associated with the UE 1802 (e.g., as shown in 1702 with reference to FIG. 17), a sidelink grant associated with the UE 1802 (e.g., as shown in 1702 with reference to FIG. 17), a WUS configuration associated with the UE 1802 (e.g., as shown in 1608 with reference to FIG. 16), or a sensing-based resource selection for a mode 2 sidelink communication associated with the UE 1802. Further, the panel/controller of the network node 1804 may be switched off to conserve power when the UE 1802 may not be expected to transmit and/or receive. The time periods during which the UE 1802 may not be expected to transmit and/or receive may be identified based on some of the same factors as described above.

In one configuration, the network node 1804 may include a RIS.

At 1808, the UE 1802 may transmit, via the transceiver, to the network node 1804, the on-off pattern configuration for the network node 1804.

In one configuration, the on-off pattern configuration for the network node 1804 may be associated with one or more of a pattern ID, an ID associated with the UE 1802, a UE group ID associated with the UE 1802, a TCI state, or a priority.

In one configuration, based on the on-off pattern configuration for the network node 1804, the panel of the network node 1804 or the controller of the network node 1804 may be on during a first period corresponding to a DRX on duration associated with the UE 1802.

In one configuration, at 1810, the UE 1802 may transmit, via the transceiver, during the first period, to the network node 1804, a configuration associated with a second period. The second period may be immediately subsequent to the first period. The panel of the network node 1804 or the controller of the network node 1804 may be on during the second period based on the configuration associated with the second period.

In one configuration, at 1814, the UE 1802 may transmit, via the transceiver, to a network entity 1812 (e.g., a base station), an indication of whether the network node 1804 accepts the configuration associated with the second period.

In one configuration, the panel of the network node 1804 or the controller of the network node 1804 may be on during a second period corresponding to an extended DRX on duration associated with the UE 1802 based on a number of preconfigured redundancy slots immediately subsequent to the first period. The second period may be immediately subsequent to the first period.

In one configuration, the configuration associated with the second period at 1810 may be further associated with at least one of an ID of the UE 1802, timing information, or beam information.

In one configuration, at 1816, the UE 1802 may transmit, via the transceiver, during the first period, to the network node 1804, a configuration associated with a third period corresponding to an increased DRX on duration associated with the UE 1802. The panel of the network node 1804 or the controller of the network node 1804 may be on during the third period based on the configuration associated with the third period. The increased DRX on duration may be based on cross slot scheduling.

In one configuration, the configuration associated with the third period may be further associated with at least one of an ID of the UE 1802, timing information, or beam information.

At 1818, the network node 1804 may switch the panel of the network node 1804 or the controller of the network node 1804 on or off based on the on-off pattern configuration for the network node 1804.

In one configuration, at 1820, the UE 1802 may transmit, via the transceiver, to the network node 1804, an indication to activate or deactivate the on-off pattern configuration for the network node 1804.

In one configuration, at 1822, the network node 1804 may transmit, to the UE 1802, an indication of whether the on-off pattern configuration for the network node 1804 is active.

In one configuration, at 1826, the network node 1804 may receive, from a second UE or a network entity 1824 (e.g., a base station), a second on-off pattern configuration for the network node 1804. The second on-off pattern configuration for the network node 1804 may be associated with the panel of the network node 1804 or the controller of the network node 1804. The panel of the network node 1804 or the controller of the network node 1804 may be switched on or off based further on the second on-off pattern configuration for the network node 1804.

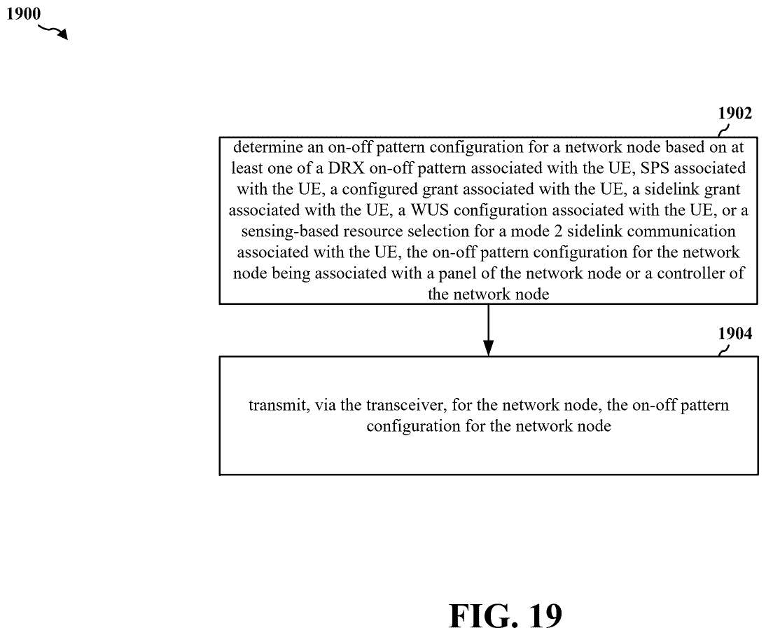

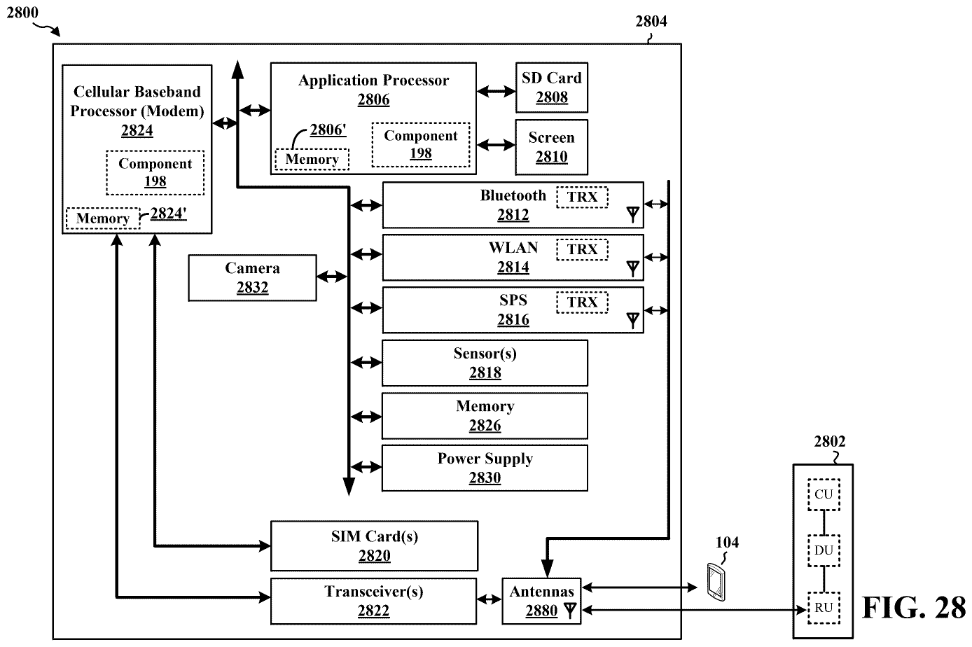

FIG. 19 is a flowchart 1900 of a method of wireless communication. The method may be performed by a UE (e.g., the UE 104/350/1802; the apparatus 2804). At 1902, the UE may determine an on-off pattern configuration for a network node based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The on-off pattern configuration for the network node may be associated with a panel of the network node or a controller of the network node. For example, 1902 may be performed by the component 198 in FIG. 28. Referring to FIG. 18, at 1806, the UE 1802 may determine an on-off pattern configuration for a network node 1804 based on at least one of a DRX on-off pattern associated with the UE 1802, SPS associated with the UE 1802, a configured grant associated with the UE 1802, a sidelink grant associated with the UE 1802, a WUS configuration associated with the UE 1802, or a sensing-based resource selection for a mode 2 sidelink communication associated with the UE 1802.

At 1904, the UE may transmit, via the transceiver, to the network node, the on-off pattern configuration for the network node. For example, 1904 may be performed by the component 198 in FIG. 28. Referring to FIG. 18, at 1808, the UE 1802 may transmit, via the transceiver, to the network node 1804, the on-off pattern configuration for the network node 1804.

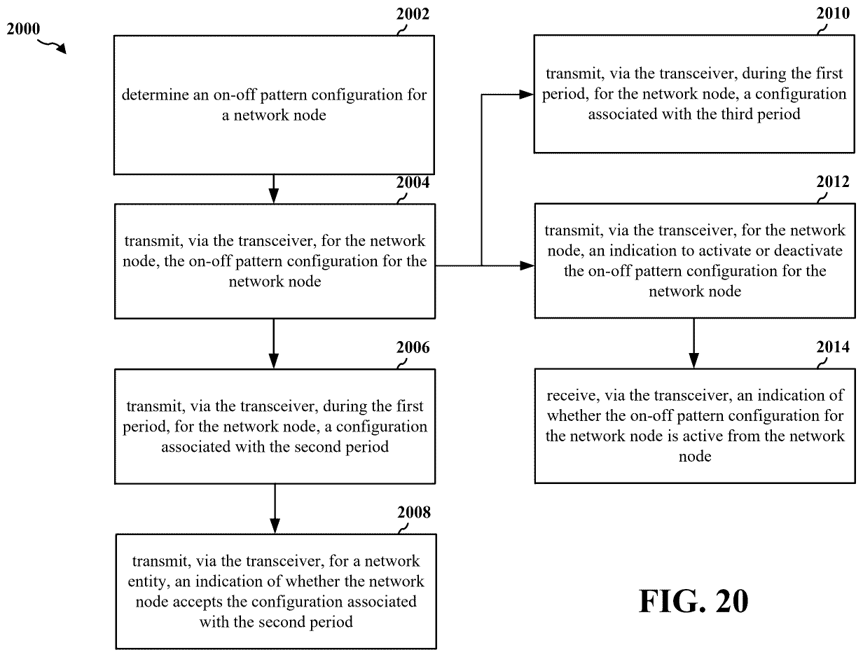

FIG. 20 is a flowchart 2000 of a method of wireless communication. The method may be performed by a UE (e.g., the UE 104/350/1802; the apparatus 2804). At 2002, the UE may determine an on-off pattern configuration for a network node based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The on-off pattern configuration for the network node may be associated with a panel of the network node or a controller of the network node. For example, 2002 may be performed by the component 198 in FIG. 28. Referring to FIG. 18, at 1806, the UE 1802 may determine an on-off pattern configuration for a network node 1804 based on at least one of a DRX on-off pattern associated with the UE 1802, SPS associated with the UE 1802, a configured grant associated with the UE 1802, a sidelink grant associated with the UE 1802, a WUS configuration associated with the UE 1802, or a sensing-based resource selection for a mode 2 sidelink communication associated with the UE 1802.

At 2004, the UE may transmit, via the transceiver, to the network node, the on-off pattern configuration for the network node. For example, 2004 may be performed by the component 198 in FIG. 28. Referring to FIG. 18, at 1808, the UE 1802 may transmit, via the transceiver, to the network node 1804, the on-off pattern configuration for the network node 1804.

In one configuration, referring to FIG. 18, based on the on-off pattern configuration for the network node 1804, the panel of the network node 1804 or the controller of the network node 1804 may be on during a first period corresponding to a DRX on duration associated with the UE 1802.

In one configuration, referring to FIG. 18, the panel of the network node 1804 or the controller of the network node 1804 may be on during a second period corresponding to an extended DRX on duration associated with the UE 1802 based on a number of preconfigured redundancy slots immediately subsequent to the first period. The second period may be immediately subsequent to the first period.

In one configuration, at 2006, the UE may transmit, via the transceiver, during the first period, to the network node, a configuration associated with a second period corresponding to an extended DRX on duration associated with the UE. The second period may be immediately subsequent to the first period. The panel of the network node or the controller of the network node may be on during the second period based on the configuration associated with the second period. For example, 2006 may be performed by the component 198 in FIG. 28. Referring to FIG. 18, at 1810, the UE 1802 may transmit, via the transceiver, during the first period, to the network node 1804, a configuration associated with a second period corresponding to an extended DRX on duration associated with the UE 1802.

In one configuration, referring to FIG. 18, the configuration associated with the second period at 1810 may be further associated with at least one of an ID of the UE 1802, timing information, or beam information.

In one configuration, at 1808, the UE may transmit, via the transceiver, to a network entity, an indication of whether the network node accepts the configuration associated with the second period. For example, 2008 may be performed by the component 198 in FIG. 28. Referring to FIG. 18, at 1814, the UE 1802 may transmit, via the transceiver, to a network entity 1812, an indication of whether the network node 1804 accepts the configuration associated with the second period.

In one configuration, at 2010, the UE may transmit, via the transceiver, during the first period, to the network node, a configuration associated with a third period corresponding to an increased DRX on duration associated with the UE. The panel of the network node or the controller of the network node may be on during the third period based on the configuration associated with the third period. The increased DRX on duration may be based on cross slot scheduling. For example, 2010 may be performed by the component 198 in FIG. 28. Referring to FIG. 18, at 1816, the UE 1802 may transmit, via the transceiver, during the first period, to the network node 1804, a configuration associated with a third period corresponding to an increased DRX on duration associated with the UE 1802.

In one configuration, referring to FIG. 18, the configuration associated with the third period may be further associated with at least one of an ID of the UE 1802, timing information, or beam information.

In one configuration, at 2012, the UE may transmit, via the transceiver, to the network node, an indication to activate or deactivate the on-off pattern configuration for the network node. For example, 2012 may be performed by the component 198 in FIG. 28. Referring to FIG. 18, at 1820, the UE 1802 may transmit, via the transceiver, to the network node 1804, an indication to activate or deactivate the on-off pattern configuration for the network node 1804.

In one configuration, referring to FIG. 18, the on-off pattern configuration for the network node 1804 may be associated with one or more of a pattern ID, an ID associated with the UE 1802, a UE group ID associated with the UE 1802, a TCI state, or a priority.

In one configuration, at 2014, the UE may receive, via the transceiver, from the network node, an indication of whether the on-off pattern configuration for the network node is active. For example, 2014 may be performed by the component 198 in FIG. 28. Referring to FIG. 18, at 1822, the UE 1802 may receive, via the transceiver, from the network node 1804, an indication of whether the on-off pattern configuration for the network node 1804 is active.

In one configuration, referring to FIG. 18, the network node 1804 may include a RIS.

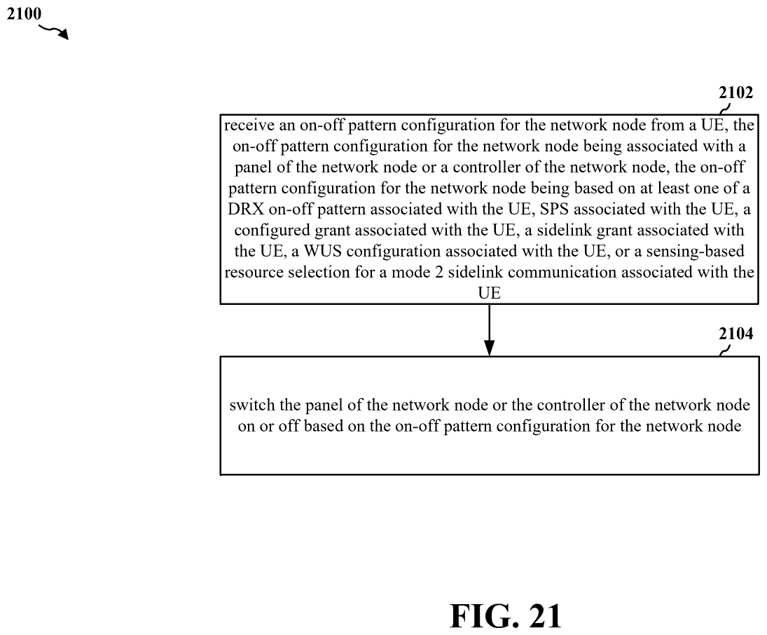

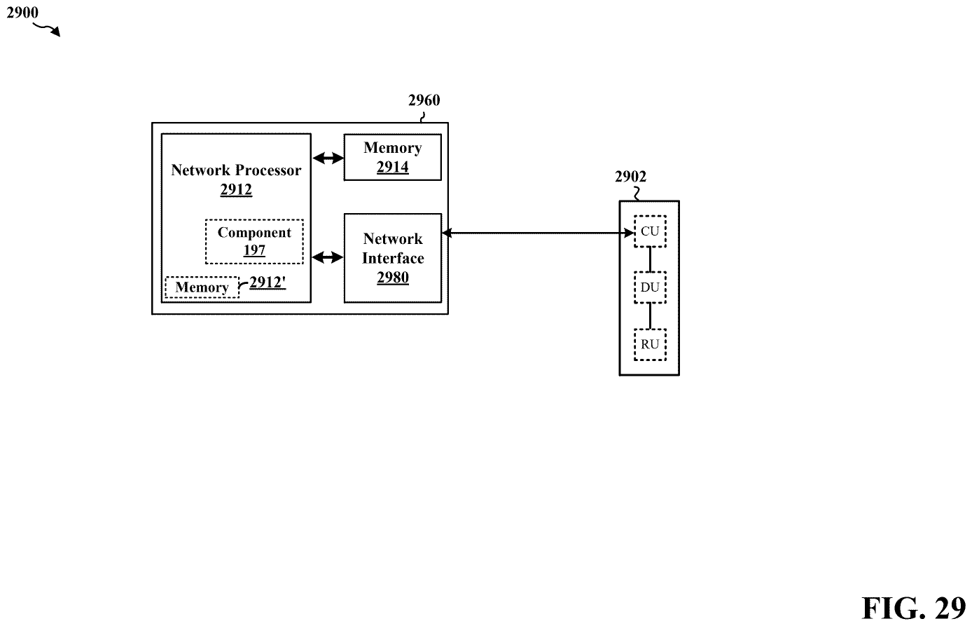

FIG. 21 is a flowchart 2100 of a method of wireless communication. The method may be performed by a network node (e.g., the RIS 107; the network node 1804; the apparatus 2960). At 2102, the network node may receive, from a UE, an on-off pattern configuration for the network node. The on-off pattern configuration for the network node may be associated with a panel of the network node or a controller of the network node. The on-off pattern configuration for the network node may be based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. For example, 2102 may be performed by the component 197 in FIG. 29. Referring to FIG. 18, at 1808, the network node 1804 may receive, from a UE 1802, an on-off pattern configuration for the network node 1804. The on-off pattern configuration for the network node 1804 may be associated with a panel of the network node 1804 or a controller of the network node 1804.

At 2104, the network node may switch the panel of the network node or the controller of the network node on or off based on the on-off pattern configuration for the network node. For example, 2104 may be performed by the component 197 in FIG. 29. Referring to FIG. 18, at 1818, the network node 1804 may switch the panel of the network node 1804 or the controller of the network node 1804 on or off based on the on-off pattern configuration for the network node 1804.

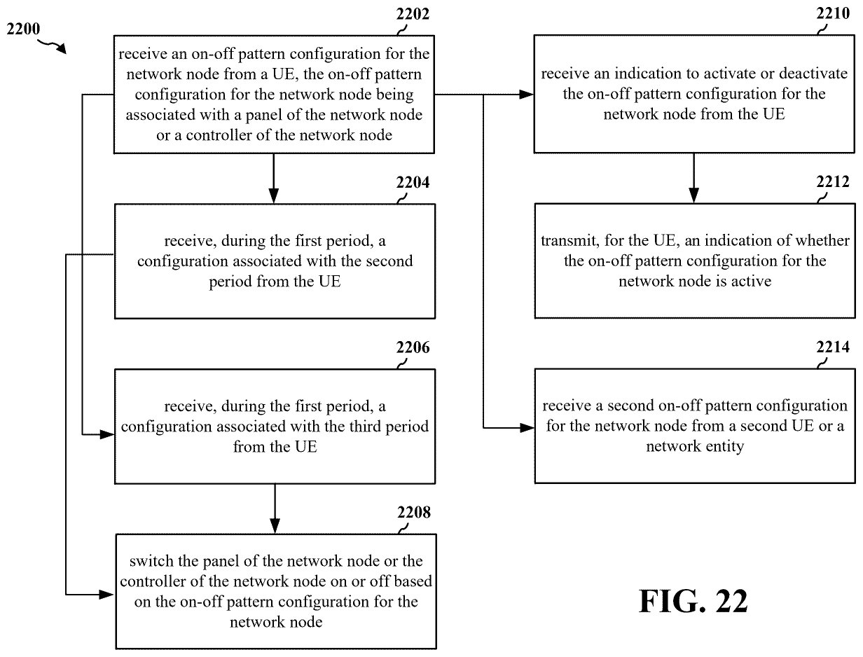

FIG. 22 is a flowchart 2200 of a method of wireless communication. The method may be performed by a network node (e.g., the RIS 107; the network node 1804; the apparatus 2960). At 2202, the network node may receive, from a UE, an on-off pattern configuration for the network node. The on-off pattern configuration for the network node may be associated with a panel of the network node or a controller of the network node. The on-off pattern configuration for the network node may be based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. For example, 2202 may be performed by the component 197 in FIG. 29. Referring to FIG. 18, at 1808, the network node 1804 may receive, from a UE 1802, an on-off pattern configuration for the network node 1804. The on-off pattern configuration for the network node 1804 may be associated with a panel of the network node 1804 or a controller of the network node 1804.

At 2208, the network node may switch the panel of the network node or the controller of the network node on or off based on the on-off pattern configuration for the network node. For example, 2208 may be performed by the component 197 in FIG. 29. Referring to FIG. 18, at 1818, the network node 1804 may switch the panel of the network node 1804 or the controller of the network node 1804 on or off based on the on-off pattern configuration for the network node 1804.

In one configuration, referring to FIG. 18, based on the on-off pattern configuration for the network node 1804, the panel of the network node 1804 or the controller of the network node 1804 may be switched on during a first period corresponding to a DRX on duration associated with the UE 1802.

In one configuration, referring to FIG. 18, the panel of the network node 1804 or the controller of the network node 1804 may be switched on during a second period corresponding to an extended DRX on duration associated with the UE 1802 based on a number of preconfigured redundancy slots immediately subsequent to the first period. The second period may be immediately subsequent to the first period.

In one configuration, at 2204, the network node may receive, from the UE, during the first period, a configuration associated with a second period corresponding to an extended DRX on duration associated with the UE. The second period may be immediately subsequent to the first period. The panel of the network node or the controller of the network node may be switched on during the second period based on the configuration associated with the second period. For example, 2204 may be performed by the component 197 in FIG. 29. Referring to FIG. 18, at 1810, the network node 1804 may receive, from the UE 1802, during the first period, a configuration associated with a second period corresponding to an extended DRX on duration associated with the UE 1802.

In one configuration, referring to FIG. 18, the configuration associated with the second period at 1810 may be further associated with at least one of an ID of the UE 1802, timing information, or beam information.

In one configuration, at 2206, the network node may receive, from the UE, during the first period, a configuration associated with a third period corresponding to an increased DRX on duration associated with the UE. The panel of the network node or the controller of the network node may be switched on during the third period based on the configuration associated with the third period. The increased DRX on duration may be based on cross slot scheduling. For example, 2206 may be performed by the component 197 in FIG. 29. Referring to FIG. 18, at 1816, the network node 1804 may receive, from the UE 1802, during the first period, a configuration associated with the third period corresponding to an increased DRX on duration associated with the UE 1802.

In one configuration, referring to FIG. 18, the configuration associated with the third period at 1816 may be further associated with at least one of an ID of the UE 1802, timing information, or beam information.

In one configuration, at 2210, the network node may receive, from the UE, an indication to activate or deactivate the on-off pattern configuration for the network node. For example, 2210 may be performed by the component 197 in FIG. 29. Referring to FIG. 18, at 1820, the network node 1804 may receive, from the UE 1802, an indication to activate or deactivate the on-off pattern configuration for the network node 1804.

In one configuration, referring to FIG. 18, the on-off pattern configuration for the network node 1804 may be associated with one or more of a pattern ID, an ID associated with the UE 1802, a UE group ID associated with the UE 1802, a TCI state, or a priority.

In one configuration, at 2212, the network node may transmit, to the UE, an indication of whether the on-off pattern configuration for the network node is active. For example, 2212 may be performed by the component 197 in FIG. 29. Referring to FIG. 18, at 1822, the network node 1804 may transmit, to the UE 1802, an indication of whether the on-off pattern configuration for the network node 1804 is active.

In one configuration, at 2214, the network node may receive, from a second UE or a network entity, a second on-off pattern configuration for the network node. The second on-off pattern configuration for the network node may be associated with the panel of the network node or the controller of the network node. The panel of the network node or the controller of the network node may be switched on or off based further on the second on-off pattern configuration for the network node. For example, 2214 may be performed by the component 197 in FIG. 29. Referring to FIG. 18, at 1626, the network node 1804 may receive, from a second UE or a network entity 1824, a second on-off pattern configuration for the network node 1804.

In one configuration, referring to FIG. 18, the panel of the network node 1804 or the controller of the network node 1804 may be switched on or off based further on a comparison between a priority associated with the on-off pattern configuration for the network node 1804 and a second priority associated with the second on-off pattern configuration for the network node 1804.

In one configuration, referring to FIG. 18, the network node 1804 may include a RIS.

In some configurations, the UE may not identify/determine the RIS on-off pattern for the RIS. Instead, the UE may simply transmit an indication of the UE communication pattern to the RIS. For example, the UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication. The RIS (e.g., the RIS controller) may identify/determine the RIS on-off pattern based on the received indication of the UE communication pattern. Thereafter, the RIS may be switched on or off based on the RIS on-off pattern.

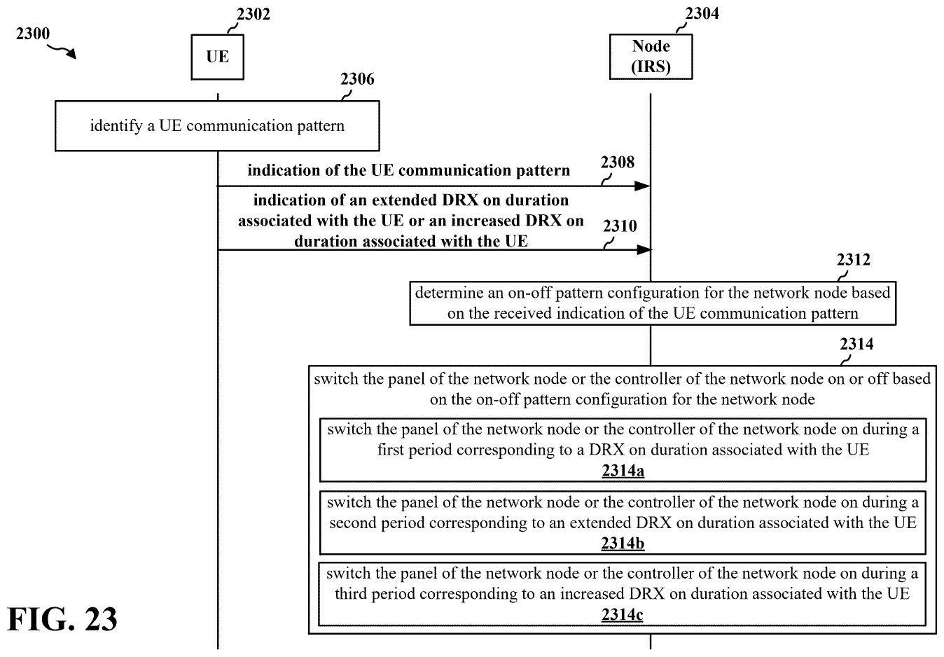

FIG. 23 is a diagram of a communication flow 2300 of a method of wireless communication. The UE 2302 may implement aspects of the UE 104/350. The network node 2304 may implement aspects of the RIS 107/406. At 2306, the UE 2302 may identify a UE communication pattern. The UE communication pattern may correspond to at least one of a DRX on-off pattern associated with the UE 2302, SPS associated with the UE 2302, a configured grant associated with the UE 2302, a sidelink grant associated with the UE 2302, a WUS configuration associated with the UE 2302, or a sensing-based resource selection for a mode 2 sidelink communication associated with the UE 2302.

At 2308, the UE 2302 may transmit, via a transceiver, to a network node 2304, an indication of the UE communication pattern.

In one configuration, at 2310, the UE 2302 may transmit, via the transceiver, to the network node 2304, an indication of an extended DRX on duration associated with the UE 2302 or an increased DRX on duration associated with the UE 2302.

At 2312, the network node 2304 may determine an on-off pattern configuration for the network node 2304 based on the received indication at 2308 of the UE communication pattern. The on-off pattern configuration for the network node 2304 may be associated with a panel of the network node 2304 or a controller of the network node 2304.

At 2314, the network node 2304 may switch the panel of the network node 2304 or the controller of the network node 2304 on or off based on the on-off pattern configuration for the network node 2304.

In one configuration, at 2314a, the network node 2304 may switch the panel of the network node 2304 or the controller of the network node 2304 on during a first period corresponding to a DRX on duration associated with the UE 2302.

In one configuration, at 2314b, the network node 2304 may switch the panel of the network node 2304 or the controller of the network node 2304 on during a second period corresponding to an extended DRX on duration associated with the UE 2302.

In one configuration, at 2314c, the network node 2304 may switch the panel of the network node 2304 or the controller of the network node 2304 on during a third period corresponding to an increased DRX on duration associated with the UE 2302.

In one configuration, the network node 2304 may include a RIS.

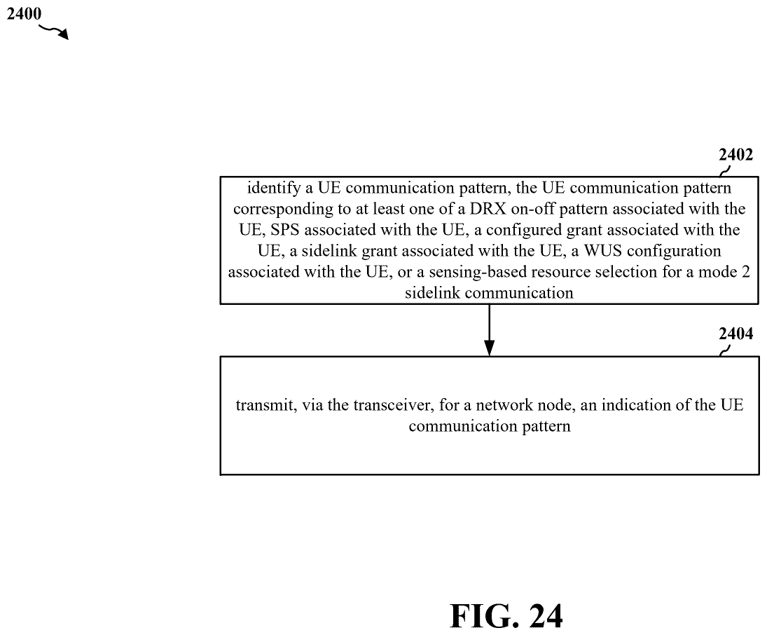

FIG. 24 is a flowchart 2400 of a method of wireless communication. The method may be performed by a UE (e.g., the UE 104/350/2302; the apparatus 2804). At 2402, the UE may identify a UE communication pattern. The UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. For example, 2402 may be performed by the component 198 in FIG. 28. Referring to FIG. 23, at 2306, the UE 2302 may identify a UE communication pattern.

At 2404, the UE may transmit, via a transceiver, to a network node, an indication of the UE communication pattern. For example, 2404 may be performed by the component 198 in FIG. 28. Referring to FIG. 23, at 2308, the UE 2302 may transmit, via a transceiver, to a network node 2304, an indication of the UE communication pattern.

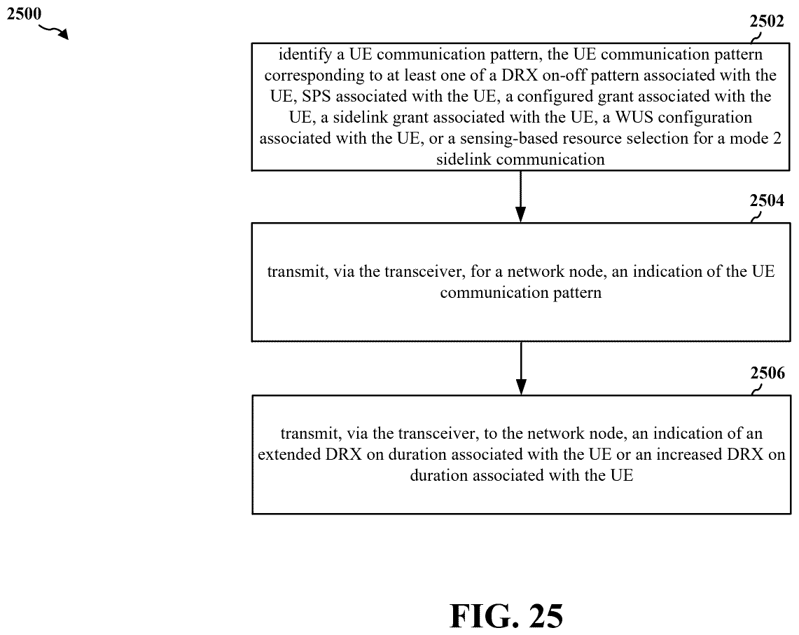

FIG. 25 is a flowchart 2500 of a method of wireless communication. The method may be performed by a UE (e.g., the UE 104/350/2302; the apparatus 2804). At 2502, the UE may identify a UE communication pattern. The UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. For example, 2502 may be performed by the component 198 in FIG. 28. Referring to FIG. 23, at 2306, the UE 2302 may identify a UE communication pattern.

At 2504, the UE may transmit, via a transceiver, to a network node, an indication of the UE communication pattern. For example, 2504 may be performed by the component 198 in FIG. 28. Referring to FIG. 23, at 2308, the UE 2302 may transmit, via a transceiver, to a network node 2304, an indication of the UE communication pattern.

In one configuration, at 2506, the UE may transmit, via the transceiver, to the network node, an indication of an extended DRX on duration associated with the UE or an increased DRX on duration associated with the UE. For example, 2506 may be performed by the component 198 in FIG. 28. Referring to FIG. 23, at 2310, the UE 2302 may transmit, via the transceiver, to the network node 2304, an indication of an extended DRX on duration associated with the UE 2302 or an increased DRX on duration associated with the UE 2302.

In one configuration, referring to FIG. 23, the network node 2304 may include a RIS.

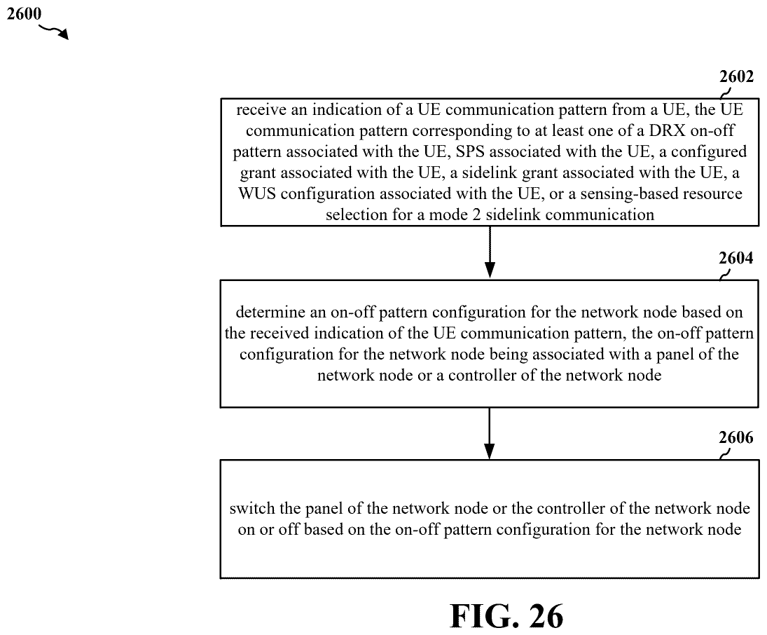

FIG. 26 is a flowchart 2600 of a method of wireless communication. The method may be performed by a network node (e.g., the RIS 107; the network node 2304; the apparatus 2960). At 2602, the network node may receive, from a UE, an indication of a UE communication pattern. The UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. For example, 2602 may be performed by the component 197 in FIG. 29. Referring to FIG. 23, at 2308, the network node 2304 may receive, from a UE 2302, an indication of a UE communication pattern.

At 2604, the network node may determine an on-off pattern configuration for the network node based on the received indication of the UE communication pattern. The on-off pattern configuration for the network node may be associated with a panel of the network node or a controller of the network node. For example, 2604 may be performed by the component 197 in FIG. 29. Referring to FIG. 23, at 2312, the network node 2304 may determine an on-off pattern configuration for the network node 2304 based on the received indication at 2308 of the UE communication pattern.

At 2606, the network node may switch the panel of the network node or the controller of the network node on or off based on the on-off pattern configuration for the network node. For example, 2606 may be performed by the component 197 in FIG. 29. Referring to FIG. 23, at 2314, the network node 2304 may switch the panel of the network node 2304 or the controller of the network node 2304 on or off based on the on-off pattern configuration for the network node 2304.

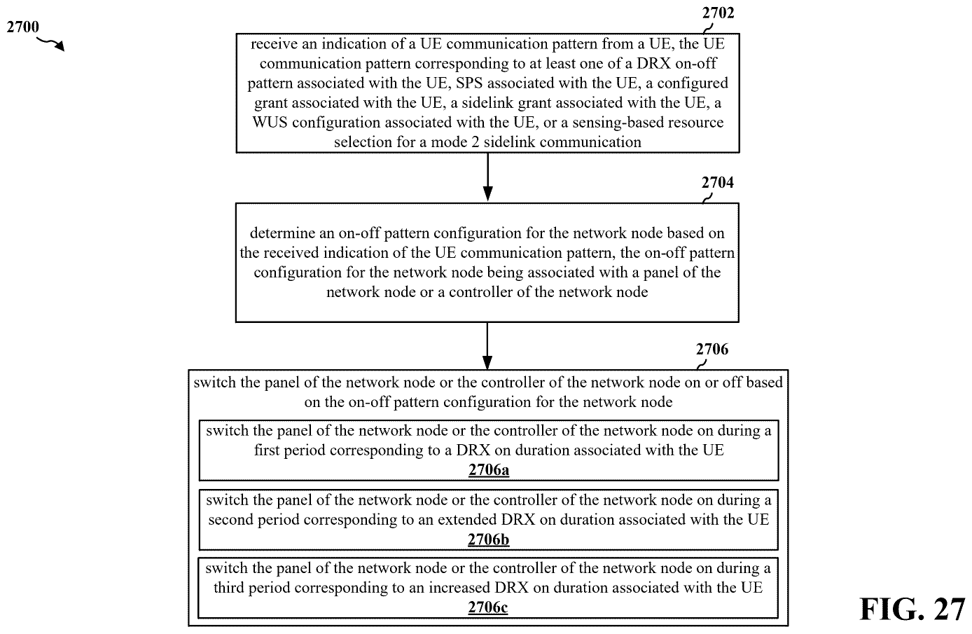

FIG. 27 is a flowchart 2700 of a method of wireless communication. The method may be performed by a network node (e.g., the RIS 107; the network node 2304; the apparatus 2960). At 2702, the network node may receive, from a UE, an indication of a UE communication pattern. The UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. For example, 2702 may be performed by the component 197 in FIG. 29. Referring to FIG. 23, at 2308, the network node 2304 may receive, from a UE 2302, an indication of a UE communication pattern.

At 2704, the network node may determine an on-off pattern configuration for the network node based on the received indication of the UE communication pattern. The on-off pattern configuration for the network node may be associated with a panel of the network node or a controller of the network node. For example, 2704 may be performed by the component 197 in FIG. 29. Referring to FIG. 23, at 2312, the network node 2304 may determine an on-off pattern configuration for the network node 2304 based on the received indication at 2308 of the UE communication pattern.

At 2706, the network node may switch the panel of the network node or the controller of the network node on or off based on the on-off pattern configuration for the network node. For example, 2706 may be performed by the component 197 in FIG. 29. Referring to FIG. 23, at 2314, the network node 2304 may switch the panel of the network node 2304 or the controller of the network node 2304 on or off based on the on-off pattern configuration for the network node 2304.

In one configuration, to switch, at 2706, the panel of the network node or the controller of the network node on or off based on the on-off pattern configuration for the network node, at 2706a, the network node may switch the panel of the network node or the controller of the network node on during a first period corresponding to a DRX on duration associated with the UE. For example, 2706a may be performed by the component 197 in FIG. 29. Referring to FIG. 23, at 2314a, the network node 2304 may switch the panel of the network node 2304 or the controller of the network node 2304 on during a first period corresponding to a DRX on duration associated with the UE 2302.

In one configuration, to switch, at 2706, the panel of the network node or the controller of the network node on or off based on the on-off pattern configuration for the network node, at 2706b, the network node may switch the panel of the network node or the controller of the network node on during a second period corresponding to an extended DRX on duration associated with the UE. For example, 2706b may be performed by the component 197 in FIG. 29. Referring to FIG. 23, at 2314b, the network node 2304 may switch the panel of the network node 2304 or the controller of the network node 2304 on during a second period corresponding to an extended DRX on duration associated with the UE 2302.

In one configuration, to switch, at 2706, the panel of the network node or the controller of the network node on or off based on the on-off pattern configuration for the network node, at 2706c, the network node may switch the panel of the network node or the controller of the network node on during a third period corresponding to an increased DRX on duration associated with the UE. For example, 2706c may be performed by the component 197 in FIG. 29. Referring to FIG. 23, at 2314c, the network node 2304 may switch the panel of the network node 2304 or the controller of the network node 2304 on during a third period corresponding to an increased DRX on duration associated with the UE 2302.

In one configuration referring to FIG. 23, the network node 2304 may include a RIS.

FIG. 28 is a diagram 2800 illustrating an example of a hardware implementation for an apparatus 2804. The apparatus 2804 may be a UE, a component of a UE, or may implement UE functionality. In some aspects, the apparatus 2804 may include a cellular baseband processor 2824 (also referred to as a modem) coupled to one or more transceivers 2822 (e.g., cellular RF transceiver). The cellular baseband processor 2824 may include on-chip memory 2824′. In some aspects, the apparatus 2804 may further include one or more subscriber identity modules (SIM) cards 2820 and an application processor 2806 coupled to a secure digital (SD) card 2808 and a screen 2810. The application processor 2806 may include on-chip memory 2806′. In some aspects, the apparatus 2804 may further include a Bluetooth module 2812, a WLAN module 2814, an SPS module 2816 (e.g., GNSS module), one or more sensor modules 2818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2826, a power supply 2830, and/or a camera 2832. The Bluetooth module 2812, the WLAN module 2814, and the SPS module 2816 may include an on-chip transceiver (TRX) (or in some cases, just a receiver (RX)). The Bluetooth module 2812, the WLAN module 2814, and the SPS module 2816 may include their own dedicated antennas and/or utilize the antennas 2880 for communication. The cellular baseband processor 2824 communicates through the transceiver(s) 2822 via one or more antennas 2880 with the UE 104 and/or with an RU associated with a network entity 2802. The cellular baseband processor 2824 and the application processor 2806 may each include a computer-readable medium/memory 2824′, 2806′, respectively. The additional memory modules 2826 may also be considered a computer-readable medium/memory. Each computer-readable medium/memory 2824′, 2806′, 2826 may be non-transitory. The cellular baseband processor 2824 and the application processor 2806 are each responsible for general processing, including the execution of software stored on the computer-readable medium/memory. The software, when executed by the cellular baseband processor 2824/application processor 2806, causes the cellular baseband processor 2824/application processor 2806 to perform the various functions described supra. The computer-readable medium/memory may also be used for storing data that is manipulated by the cellular baseband processor 2824/application processor 2806 when executing software. The cellular baseband processor 2824/application processor 2806 may be a component of the UE 350 and may include the memory 360 and/or at least one of the TX processor 368, the RX processor 356, and the controller/processor 359. In one configuration, the apparatus 2804 may be a processor chip (modem and/or application) and include just the cellular baseband processor 2824 and/or the application processor 2806, and in another configuration, the apparatus 2804 may be the entire UE (e.g., see UE 350 of FIG. 3) and include the additional modules of the apparatus 2804.

As discussed supra, the component 198 may be configured to determine an on-off pattern configuration for a network node based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The on-off pattern configuration for the network node may be associated with a panel of the network node or a controller of the network node. The component 198 may be configured to transmit, via the transceiver, to the network node, the on-off pattern configuration for the network node. The component 198 may be within the cellular baseband processor 2824, the application processor 2806, or both the cellular baseband processor 2824 and the application processor 2806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2804 may include a variety of components configured for various functions. In one configuration, the apparatus 2804, and in particular the cellular baseband processor 2824 and/or the application processor 2806, may include means for determining an on-off pattern configuration for a network node based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The on-off pattern configuration for the network node may be associated with a panel of the network node or a controller of the network node. The apparatus 2804, and in particular the cellular baseband processor 2824 and/or the application processor 2806, may include means for transmitting, via the transceiver, to the network node, the on-off pattern configuration for the network node.

In one configuration, based on the on-off pattern configuration for the network node, the panel of the network node or the controller of the network node may be on during a first period corresponding to a DRX on duration associated with the UE. In one configuration, the panel of the network node or the controller of the network node may be on during a second period corresponding to an extended DRX on duration associated with the UE based on a number of preconfigured redundancy slots immediately subsequent to the first period. The second period may be immediately subsequent to the first period. In one configuration, the apparatus 2804, and in particular the cellular baseband processor 2824 and/or the application processor 2806, may include means for transmitting, via the transceiver, during the first period, to the network node, a configuration associated with a second period corresponding to an extended DRX on duration associated with the UE. The second period may be immediately subsequent to the first period. The panel of the network node or the controller of the network node may be on during the second period based on the configuration associated with the second period. In one configuration, the configuration associated with the second period may be further associated with at least one of an ID of the UE, timing information, or beam information. In one configuration, the apparatus 2804, and in particular the cellular baseband processor 2824 and/or the application processor 2806, may include means for transmitting, via the transceiver, to a network entity, an indication of whether the network node accepts the configuration associated with the second period. In one configuration, the apparatus 2804, and in particular the cellular baseband processor 2824 and/or the application processor 2806, may include means for transmitting, via the transceiver, during the first period, to the network node, a configuration associated with a third period corresponding to an increased DRX on duration associated with the UE. The panel of the network node or the controller of the network node may be on during the third period based on the configuration associated with the third period. The increased DRX on duration may be based on cross slot scheduling. In one configuration, the configuration associated with the third period may be further associated with at least one of an ID of the UE, timing information, or beam information. In one configuration, the apparatus 2804, and in particular the cellular baseband processor 2824 and/or the application processor 2806, may include means for transmitting, via the transceiver, to the network node, an indication to activate or deactivate the on-off pattern configuration for the network node. In one configuration, the on-off pattern configuration for the network node may be associated with one or more of a pattern ID, an ID associated with the UE, a UE group ID associated with the UE, a TCI state, or a priority. In one configuration, the apparatus 2804, and in particular the cellular baseband processor 2824 and/or the application processor 2806, may include means for receiving, via the transceiver, from the network node, an indication of whether the on-off pattern configuration for the network node is active. In one configuration, the network node may include a RIS.

In some configurations, the component 198 may be configured to identify a UE communication pattern. The UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The component 198 may be configured to transmit, via the transceiver, to a network node, an indication of the UE communication pattern. In one configuration, the apparatus 2804, and in particular the cellular baseband processor 2824 and/or the application processor 2806, may include means for identifying a UE communication pattern. The UE communication pattern may correspond to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The apparatus 2804, and in particular the cellular baseband processor 2824 and/or the application processor 2806, may include means for transmitting, via the transceiver, to a network node, an indication of the UE communication pattern.

In one configuration, the apparatus 2804, and in particular the cellular baseband processor 2824 and/or the application processor 2806, may include means for transmitting, via the transceiver, to the network node, an indication of an extended DRX on duration associated with the UE or an increased DRX on duration associated with the UE. In one configuration, the network node may include a RIS.

The means may be the component 198 of the apparatus 2804 configured to perform the functions recited by the means. As described supra, the apparatus 2804 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 29 is a diagram 2900 illustrating an example of a hardware implementation for a network entity 2960. In one example, the network entity 2960 may be within the core network 120. The network entity 2960 may include a network processor 2912. The network processor 2912 may include on-chip memory 2912′. In some aspects, the network entity 2960 may further include additional memory modules 2914. The network entity 2960 communicates via the network interface 2980 directly (e.g., backhaul link) or indirectly (e.g., through a RIC) with the CU 2902. The on-chip memory 2912′ and the additional memory modules 2914 may each be considered a computer-readable medium/memory. Each computer-readable medium/memory may be non-transitory. The processor 2912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 197 may be configured to receive, from a UE, an on-off pattern configuration for the network node. The on-off pattern configuration for the network node may be associated with a panel of the network node or a controller of the network node. The on-off pattern configuration for the network node may be based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The component 197 may be configured to switch the panel of the network node or the controller of the network node on or off based on the on-off pattern configuration for the network node. The component 197 may be within the processor 2912. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2960 may include a variety of components configured for various functions. In one configuration, the network entity 2960 may include means for receiving, from a UE, an on-off pattern configuration for the network node. The on-off pattern configuration for the network node may be associated with a panel of the network node or a controller of the network node. The on-off pattern configuration for the network node may be based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The network entity 2960 may include means for switching the panel of the network node or the controller of the network node on or off based on the on-off pattern configuration for the network node.

In one configuration, based on the on-off pattern configuration for the network node, the panel of the network node or the controller of the network node may be switched on during a first period corresponding to a DRX on duration associated with the UE. In one configuration, the panel of the network node or the controller of the network node may be switched on during a second period corresponding to an extended DRX on duration associated with the UE based on a number of preconfigured redundancy slots immediately subsequent to the first period. The second period may be immediately subsequent to the first period. In one configuration, the network entity 2960 may include means for receiving, from the UE, during the first period, a configuration associated with a second period corresponding to an extended DRX on duration associated with the UE. The second period may be immediately subsequent to the first period. The panel of the network node or the controller of the network node may be switched on during the second period based on the configuration associated with the second period. In one configuration, the configuration associated with the second period may be further associated with at least one of an ID of the UE, timing information, or beam information. In one configuration, the network entity 2960 may include means for receiving, from the UE, during the first period, a configuration associated with a third period corresponding to an increased DRX on duration associated with the UE. The panel of the network node or the controller of the network node may be switched on during the third period based on the configuration associated with the third period. The increased DRX on duration may be based on cross slot scheduling. In one configuration, the configuration associated with the third period may be further associated with at least one of an ID of the UE, timing information, or beam information. In one configuration, the network entity 2960 may include means for receiving, from the UE, an indication to activate or deactivate the on-off pattern configuration for the network node. In one configuration, the on-off pattern configuration for the network node may be associated with one or more of a pattern ID, an ID associated with the UE, a UE group ID associated with the UE, a TCI state, or a priority. In one configuration, the network entity 2960 may include means for transmitting, to the UE, an indication of whether the on-off pattern configuration for the network node is active. In one configuration, the network entity 2960 may include means for receiving, from a second UE or a network entity, a second on-off pattern configuration for the network node, the second on-off pattern configuration for the network node being associated with the panel of the network node or the controller of the network node. The panel of the network node or the controller of the network node may be switched on or off based further on the second on-off pattern configuration for the network node. In one configuration, the panel of the network node or the controller of the network node may be switched on or off based further on a comparison between a priority associated with the on-off pattern configuration for the network node and a second priority associated with the second on-off pattern configuration for the network node. In one configuration, the network node may include a RIS.

In one configuration, the component 197 may be configured to receive, from a UE, an indication of a UE communication pattern, the UE communication pattern corresponding to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The component 197 may be configured to determine an on-off pattern configuration for the network node based on the received indication of the UE communication pattern, the on-off pattern configuration for the network node being associated with a panel of the network node or a controller of the network node. The component 197 may be configured to switch the panel of the network node or the controller of the network node on or off based on the on-off pattern configuration for the network node. In one configuration, the network entity 2960 may include means for receiving, from a UE, an indication of a UE communication pattern, the UE communication pattern corresponding to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The network entity 2960 may include means for determining an on-off pattern configuration for the network node based on the received indication of the UE communication pattern, the on-off pattern configuration for the network node being associated with a panel of the network node or a controller of the network node. The network entity 2960 may include means for switching the panel of the network node or the controller of the network node on or off based on the on-off pattern configuration for the network node.

In one configuration, the means for switching the panel of the network node or the controller of the network node on or off based on the on-off pattern configuration for the network node may be further configured to switch the panel of the network node or the controller of the network node on during a first period corresponding to a DRX on duration associated with the UE. In one configuration, the means for switching the panel of the network node or the controller of the network node on or off based on the on-off pattern configuration for the network node may be further configured to switch the panel of the network node or the controller of the network node on during a second period corresponding to an extended DRX on duration associated with the UE. In one configuration, the means for switching the panel of the network node or the controller of the network node on or off based on the on-off pattern configuration for the network node may be further configured to switch the panel of the network node or the controller of the network node on during a third period corresponding to an increased DRX on duration associated with the UE. In one configuration, the network node may include a RIS.

The means may be the component 197 of the network entity 2960 configured to perform the functions recited by the means.

Referring back to FIGS. 4-29, a UE may determine an on-off pattern configuration for a network node based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE. The on-off pattern configuration for the network node may be associated with a panel of the network node or a controller of the network node. The UE may transmit, via the transceiver, to the network node, the on-off pattern configuration for the network node. The network node may switch the panel of the network node or the controller of the network node on or off based on the on-off pattern configuration for the network node. Accordingly, in some configurations, the RIS may be switched off to reduce interference and save power while the UE is in the DRX off duration, and may be switched on to serve the UE while the UE is in the DRX on duration.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including determining an on-off pattern configuration for a network node based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE, the on-off pattern configuration for the network node being associated with a panel of the network node or a controller of the network node; and transmitting, to the network node, the on-off pattern configuration for the network node.

Aspect 2 is the method of aspect 1, where based on the on-off pattern configuration for the network node, the panel of the network node or the controller of the network node is on during a first period corresponding to a DRX on duration associated with the UE.

Aspect 3 is the method of aspect 2, where the panel of the network node or the controller of the network node is on during a second period corresponding to an extended DRX on duration associated with the UE based on a number of preconfigured redundancy slots immediately subsequent to the first period, where the second period is immediately subsequent to the first period.

Aspect 4 is the method of aspect 2, further including: transmitting, during the first period, to the network node, a configuration associated with a second period corresponding to an extended DRX on duration associated with the UE, where the second period is immediately subsequent to the first period, and the panel of the network node or the controller of the network node is on during the second period based on the configuration associated with the second period.

Aspect 5 is the method of aspect 4, where the configuration associated with the second period is further associated with at least one of an ID of the UE, timing information, or beam information.

Aspect 6 is the method of any of aspects 4 and 5, further including: transmitting, to a network entity, an indication of whether the network node accepts the configuration associated with the second period.

Aspect 7 is the method of aspect 2, further including: transmitting, during the first period, to the network node, a configuration associated with a third period corresponding to an increased DRX on duration associated with the UE, where the panel of the network node or the controller of the network node is on during the third period based on the configuration associated with the third period, and the increased DRX on duration is based on cross slot scheduling.

Aspect 8 is the method of aspect 7, where the configuration associated with the third period is further associated with at least one of an ID of the UE, timing information, or beam information.

Aspect 9 is the method of any of aspects 1 to 8, further including: transmitting, to the network node, an indication to activate or deactivate the on-off pattern configuration for the network node.

Aspect 10 is the method of any of aspects 1 to 9, where the on-off pattern configuration for the network node is associated with one or more of a pattern ID, an ID associated with the UE, a UE group ID associated with the UE, a TCI state, or a priority.

Aspect 11 is the method of any of aspects 1 to 10, further including: receiving, from the network node, an indication of whether the on-off pattern configuration for the network node is active.

Aspect 12 is the method of any of aspects 1 to 11, where the network node includes a RIS.

Aspect 13 is a method of wireless communication at a network node, including receiving, from a UE, an on-off pattern configuration for the network node, the on-off pattern configuration for the network node being associated with a panel of the network node or a controller of the network node, the on-off pattern configuration for the network node being based on at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE; and switching the panel of the network node or the controller of the network node on or off based on the on-off pattern configuration for the network node.

Aspect 14 is the method of aspect 13, where the on-off pattern configuration for the network node indicates that the panel of the network node or the controller of the network node is to be switched on during a first period corresponding to a DRX on duration associated with the UE.

Aspect 15 is the method of aspect 14, where the on-off pattern configuration for the network node further indicates that the panel of the network node or the controller of the network node is to be switched on during a second period corresponding to an extended DRX on duration associated with the UE, where the second period includes a number of preconfigured redundancy slots immediately subsequent to the first period, and the second period is immediately subsequent to the first period.

Aspect 16 is the method of aspect 14, further including: receiving, from the UE, during the first period, a configuration associated with a second period corresponding to an extended DRX on duration associated with the UE, where the second period is immediately subsequent to the first period, and the configuration associated with the second period indicates that the panel of the network node or the controller of the network node is to be switched on during the second period.

Aspect 17 is the method of aspect 16, where the configuration associated with the second period is further associated with at least one of an ID of the UE, timing information, or beam information.

Aspect 18 is the method of aspect 14, further including: receiving, from the UE, during the first period, a configuration associated with a third period corresponding to an increased DRX on duration associated with the UE, where the configuration associated with the third period indicates that the panel of the network node or the controller of the network node is switched on during the third period, and the increased DRX on duration is based on cross slot scheduling.

Aspect 19 is the method of aspect 18, where the configuration associated with the third period is further associated with at least one of an ID of the UE, timing information, or beam information.

Aspect 20 is the method of any of aspects 13 to 19, further including: receiving, from the UE, an indication to activate or deactivate the on-off pattern configuration for the network node.

Aspect 21 is the method of any of aspects 13 to 20, where the on-off pattern configuration for the network node is associated with one or more of a pattern ID, an ID associated with the UE, a UE group ID associated with the UE, a TCI state, or a priority.

Aspect 22 is the method of any of aspects 13 to 21, further including: transmitting, to the UE, an indication of whether the on-off pattern configuration for the network node is active.

Aspect 23 is the method of any of aspects 13 to 22, further including: receiving, from a second UE or a network entity, a second on-off pattern configuration for the network node, the second on-off pattern configuration for the network node being associated with the panel of the network node or the controller of the network node, where the panel of the network node or the controller of the network node is switched on or off based further on the second on-off pattern configuration for the network node.

Aspect 24 is the method of aspect 23, where the panel of the network node or the controller of the network node is switched on or off based further on a comparison between a priority associated with the on-off pattern configuration for the network node and a second priority associated with the second on-off pattern configuration for the network node.

Aspect 25 is the method of any of aspects 13 to 24, where the network node includes a RIS.

Aspect 26 is a method of wireless communication at a UE, including identifying a UE communication pattern, the UE communication pattern corresponding to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE; and transmitting, to a network node, an indication of the UE communication pattern.

Aspect 27 is the method of aspect 26, further including: transmitting, via the transceiver, to the network node, an indication of an extended DRX on duration associated with the UE or an increased DRX on duration associated with the UE.

Aspect 28 is the method of any of claims 26 and 27, where the network node includes a RIS.

Aspect 29 is a method of wireless communication at a network node, including receiving, from a UE, an indication of a UE communication pattern, the UE communication pattern corresponding to at least one of a DRX on-off pattern associated with the UE, SPS associated with the UE, a configured grant associated with the UE, a sidelink grant associated with the UE, a WUS configuration associated with the UE, or a sensing-based resource selection for a mode 2 sidelink communication associated with the UE; determining an on-off pattern configuration for the network node based on the received indication of the UE communication pattern, the on-off pattern configuration for the network node being associated with a panel of the network node or a controller of the network node; and switching the panel of the network node or the controller of the network node on or off based on the on-off pattern configuration for the network node.

Aspect 30 is the method of aspect 29, where switching the panel of the network node or the controller of the network node on or off based on the on-off pattern configuration for the network node further includes switching the panel of the network node or the controller of the network node on during a first period corresponding to a DRX on duration associated with the UE.

Aspect 31 is the method of aspect 30, where switching the panel of the network node or the controller of the network node on or off based on the on-off pattern configuration for the network node further includes switching the panel of the network node or the controller of the network node on during a second period corresponding to an extended DRX on duration associated with the UE, or switching the panel of the network node or the controller of the network node on during a third period corresponding to an increased DRX on duration associated with the UE.

Aspect 32 is the method of any of aspects 29 to 31, where the network node includes a RIS.

Aspect 33 is an apparatus for wireless communication including at least one processor coupled to a memory and, based at least in part on information stored in the memory, the at least one processor is configured to implement a method as in any of aspects 1 to 32.

Aspect 34 may be combined with aspect 33 and further includes a transceiver coupled to the at least one processor.

Aspect 35 is an apparatus for wireless communication including means for implementing any of aspects 1 to 32.

Aspect 36 is a non-transitory computer-readable storage medium storing computer executable code, where the code when executed by a processor causes the processor to implement any of aspects 1 to 32.

Various aspects have been described herein. These and other aspects are within the scope of the following claims.

1. An apparatus for wireless communication at a user equipment (UE), comprising:
a memory;
a transceiver; and
at least one processor coupled to the memory and the transceiver and, based at least in part on information stored in the memory, the at least one processor is configured to:
determine an on-off pattern configuration for a network node based on at least one of a discontinuous reception (DRX) on-off pattern associated with the UE, semi-persistent scheduling (SPS) associated with the UE, a configured grant associated with the UE, a sidelink grant associated with the UE, a wakeup signal (WUS) configuration associated with the UE, or a sensing-based resource selection for a mode 2 sidelink communication associated with the UE, the on-off pattern configuration for the network node being associated with a panel of the network node or a controller of the network node; and
transmit, via the transceiver, to the network node, the on-off pattern configuration for the network node.

2. The apparatus of claim 1, wherein the at least one processor is configured to determine that the on-off pattern configuration comprises the panel of the network node or the controller of the network node being on during a first period corresponding to a DRX on duration associated with the UE.

3. The apparatus of claim 2, wherein the at least one processor is configured to determine that the on-off pattern configuration comprises the panel of the network node or the controller of the network node being on during a second period corresponding to an extended DRX on duration associated with the UE based on a number of preconfigured redundancy slots immediately subsequent to the first period, and the second period is immediately subsequent to the first period.

4. The apparatus of claim 2, the at least one processor being further configured to:
transmit, via the transceiver, during the first period, to the network node, a configuration associated with a second period corresponding to an extended DRX on duration associated with the UE, wherein the second period is immediately subsequent to the first period, and the panel of the network node or the controller of the network node is on during the second period based on the configuration associated with the second period.

5. The apparatus of claim 4, wherein the configuration associated with the second period is further associated with at least one of an identifier (ID) of the UE, timing information, or beam information.

6. The apparatus of claim 4, the at least one processor being further configured to:
transmit, via the transceiver, to a network entity, an indication of whether the network node accepts the configuration associated with the second period.

7. The apparatus of claim 2, the at least one processor being further configured to:
transmit, via the transceiver, during the first period, to the network node, a configuration associated with a third period corresponding to an increased DRX on duration associated with the UE, wherein the panel of the network node or the controller of the network node is on during the third period based on the configuration associated with the third period, and the increased DRX on duration is based on cross slot scheduling.

8. The apparatus of claim 7, wherein the configuration associated with the third period is further associated with at least one of an identifier (ID) of the UE, timing information, or beam information.

9. The apparatus of claim 1, the at least one processor being further configured to:
transmit, via the transceiver, to the network node, an indication to activate or deactivate the on-off pattern configuration for the network node, or
receive, via the transceiver, from the network node, an indication of whether the on-off pattern configuration for the network node is active, or
both.

10. The apparatus of claim 1, wherein the on-off pattern configuration for the network node is associated with one or more of a pattern identifier (ID), an ID associated with the UE, a UE group ID associated with the UE, a transmission configuration indicator (TCI) state, or a priority.

11. The apparatus of claim 1, wherein the network node includes a reconfigurable intelligent surface (RIS).

12. A method of wireless communication at a user equipment (UE), comprising:
determining an on-off pattern configuration for a network node based on at least one of a discontinuous reception (DRX) on-off pattern associated with the UE, semi-persistent scheduling (SPS) associated with the UE, a configured grant associated with the UE, a sidelink grant associated with the UE, a wakeup signal (WUS) configuration associated with the UE, or a sensing-based resource selection for a mode 2 sidelink communication associated with the UE, the on-off pattern configuration for the network node being associated with a panel of the network node or a controller of the network node; and
transmitting, to the network node, the on-off pattern configuration for the network node.

13.-26. (canceled)

27. An apparatus for wireless communication at a user equipment (UE), comprising:
a memory;
a transceiver; and
at least one processor coupled to the memory and the transceiver and, based at least in part on information stored in the memory, the at least one processor is configured to:
identify a UE communication pattern, the UE communication pattern corresponding to at least one of a discontinuous reception (DRX) on-off pattern associated with the UE, semi-persistent scheduling (SPS) associated with the UE, a configured grant associated with the UE, a sidelink grant associated with the UE, a wakeup signal (WUS) configuration associated with the UE, or a sensing-based resource selection for a mode 2 sidelink communication associated with the UE; and
transmit, via the transceiver, to a network node, an indication of the UE communication pattern.

28. The apparatus of claim 27, the at least one processor being further configured to:
transmit, via the transceiver, to the network node, an indication of an extended DRX on duration associated with the UE or an increased DRX on duration associated with the UE.

29. The apparatus of claim 27, wherein the network node includes a reconfigurable intelligent surface (RIS).

30.-33. (canceled)

34. The method of claim 12, wherein the on-off pattern configuration comprises the panel of the network node or the controller of the network node being on during a first period corresponding to a DRX on duration associated with the UE, the method further comprising:
determining that the on-off pattern configuration comprises the panel of the network node or the controller of the network node being on during a second period corresponding to an extended DRX on duration associated with the UE based on a number of preconfigured redundancy slots immediately subsequent to the first period, and the second period is immediately subsequent to the first period.

35. The method of claim 12, wherein the on-off pattern configuration comprises the panel of the network node or the controller of the network node being on during a first period corresponding to a DRX on duration associated with the UE, the method further comprising:
transmitting, during the first period, to the network node, a configuration associated with a second period corresponding to an extended DRX on duration associated with the UE, wherein the second period is immediately subsequent to the first period, and the panel of the network node or the controller of the network node is on during the second period based on the configuration associated with the second period; and
transmitting, to a network entity, an indication of whether the network node accepts the configuration associated with the second period.

36. The method of claim 12, wherein the on-off pattern configuration comprises the panel of the network node or the controller of the network node being on during a first period corresponding to a DRX on duration associated with the UE, the method further comprising:
transmitting, during the first period, to the network node, a configuration associated with a third period corresponding to an increased DRX on duration associated with the UE, wherein the panel of the network node or the controller of the network node is on during the third period based on the configuration associated with the third period, and the increased DRX on duration is based on cross slot scheduling.

37. The method of claim 12, further comprising:
transmitting, to the network node, an indication to activate or deactivate the on-off pattern configuration for the network node, or
receiving, from the network node, an indication of whether the on-off pattern configuration for the network node is active, or
both.

38. The method of claim 12, wherein the network node includes a reconfigurable intelligent surface (RIS).
